(19) United States
(12) Patent Application Publication
(10) Pub. No.: US 2022/0135466 A1
(43) Pub. Date: May 5, 2022

(54) GLASS, CHEMICALLY STRENGTHENED GLASS, AND COVER GLASS

(71) Applicant: AGC Inc., Tokyo (JP)

(72) Inventors: Eriko MAEDA, Tokyo (JP); Kenji IMAKITA, Tokyo (JP); Kazuki KANEHARA, Tokyo (JP); Akihisa MINOWA, Tokyo (JP)

(73) Assignee: AGC Inc., Tokyo (JP)

(21) Appl. No.: 17/573,382

(22) Filed: Jan. 11, 2022

Related U.S. Application Data
(63) Continuation of application No. PCT/JP2020/027254, filed on Jul. 13, 2020.

(30) Foreign Application Priority Data
Jul. 17, 2019 (JP) 2019-132124
Jan. 20, 2020 (JP) 2020-006948

(51) Int. Cl. C03C 3/097; C03C 4/18; C03C 3/095; C03C 3/085; C03C 21/00; C03C 17/32

(52) U.S. Cl. CPC C03C 3/097; C03C 4/18; C03C 3/095; C03C 2217/76; C03C 21/002; C03C 17/32; C03C 3/085

(57) ABSTRACT

The present invention relates to a glass including, in mole percentage on an oxide basis: 60-75% of SiO₂; 8-20% of Al₂O₃; 5-16% of Li₂O; and 2-15% of one or more kinds of Na₂O and K₂O in total, in which a ratio P_{Li} of the content of Li₂O to a total content of Li₂O, Na₂O, and K₂O is 0.40 or more, and a total content of MgO, CaO, SrO, BaO, and ZnO is 0-10%.

### CROSS-REFERENCE TO RELATED APPLICATIONS

The present application is a Bypass Continuation Application of PCT/JP2020/027254, filed on Jul. 13, 2020, which claims priority to Japanese Patent Application Nos. 2019-132124 filed on Jul. 17, 2019, and 2020-006948 filed on Jan. 20, 2020. The contents of these applications are hereby incorporated by reference in their entireties.

### TECHNICAL FIELD

The present invention relates to a glass, a chemically strengthened glass, and a cover glass.

### BACKGROUND ART

Nowadays, cover glasses constituted of chemically strengthened glasses are used for the purposes of protecting the display devices such as portable telephones, smartphones, tablet devices, etc. and enhancing their appearance attractiveness.

In chemically strengthened glasses, there is a tendency that the greater the surface compressive stress (value) (CS) or the depth of compressive stress layer (DOL), the higher the strength. Meanwhile, internal tensile stress (CT) generates within the glass so as to be balanced with the surface compressive stress and, hence, the greater the CS or DOL, the higher the CT. When a glass having a high CT breaks, there is a greater risk that the number of fragments increase and the fragments are scattered.

Patent Document 1 describes a feature that surface compressive stress (CS) can be increased while inhibiting internal tensile stress (CT) from increasing, by performing a two-stage chemical strengthening treatment to thereby form a stress profile represented by a broken line.

Patent Document 2 discloses a lithium aluminosilicate glass having relatively high surface compressive stress and a relatively large depth of compressive stress layer, obtained by a two-stage chemical strengthening treatment. The lithium aluminosilicate glass can have increased values of CS and DOL while being inhibited from increasing in CT, due to a two-stage chemical strengthening treatment in which a sodium salt and a potassium salt are used.

Meanwhile, touch panels used in smartphones, etc. are apt to suffer adhesion of soils due to fingerprints, etc. because the touch panels come into contact with human fingers when used. The touch panels are further required to have suitability for finger operation on the touch panels. Patent Document 3 describes a feature of using a fluorine-containing organosilicon compound as a coating for improving antifouling properties and finger slipperiness.

### CITATION LIST

### Patent Literature

Patent Document 1: U.S. Patent Application Publication No. 2015/0259244
Patent Document 2: JP-T-2013-520388 (The term “JP-T” as used herein means a published Japanese translation of a PCT patent application.)
Patent Document 3: JP-A-2000-144097

### SUMMARY OF INVENTION

### Technical Problems

Lithium aluminosilicate glasses tend to devitrify in glass production steps or in steps for, for example, bending the obtained glasses.

Furthermore, there are cases where chemically strengthened glasses obtained by subjecting lithium aluminosilicate glasses to ion exchange treatments are prone to suffer separation of a layer for improving antifouling properties and finger slipperiness (hereinafter referred to as “antifouling layer”) therefrom.

An object of the present invention is to provide a glass which has excellent producibility and is effective in inhibiting the separation of an antifouling layer therefrom.

### Solution to the Problems

The present inventors made investigations on lithium aluminosilicate glasses and have discovered features of a glass composition having excellent producibility. The inventors further made investigations on the separation of an antifouling layer and, as a result, have discovered a tendency that the lower the surface resistivity of a glass, the more the separation is inhibited. The inventors have further discovered a tendency in chemically strengthened glasses that the higher the hopping frequency, the more the separation is inhibited. The hopping frequency of a glass is the frequency of the hopping vibration of a charge carrier which causes electrical conduction. The present invention has been completed based on these findings.

The present invention provides a glass including, in mole percentage on an oxide basis:

60-75% of SiO₂;

8-20% of Al₂O₃;

5-16% of Li₂O; and

2-15% of one or more kinds of Na₂O and K₂O in total, in which

a ratio P_{Li} of the content of Li₂O to a total content of Li₂O, Na₂O, and K₂O is 0.40 or more, and

a total content of MgO, CaO, SrO, BaO, and ZnO is 0-10%.

The present invention further provides a chemically strengthened glass having a surface compressive stress value of 600 MPa or more and having a base glass composition including, in mole percentage on an oxide basis:

60-75% of SiO₂;

8-20% of Al₂O₃;

5-16% of Li₂O; and

2-15% of one or more kinds of Na₂O and K₂O in total, in which

a ratio P_{Li} of the content of Li₂O to a total content of Li₂O, Na₂O, and K₂O is 0.40 or more,

a total content of MgO, CaO, SrO, BaO, and ZnO is 0-10%, and

the chemically strengthened glass has a hopping frequency of 10^{2.8} Hz or more.

The present invention further provides a cover glass including the chemically strengthened glass.

### Advantageous Effects of Invention

The present invention can provide a chemically strengthened glass which is less apt to devitrify and has a large surface compressive stress value (CS) and a large depth of compressive stress layer (DOL) and from which organic layers, e.g., an antifouling layer, are less apt to peel off.

### BRIEF DESCRIPTION OF DRAWINGS

FIG. 1 is a diagram showing a relationship between the surface resistivity of glasses which have not been chemically strengthened and the waterdrop contact angle after forming an antifouling layer thereon and wearing the layer under certain conditions.

FIG. 2 is a diagram showing a relationship between the surface resistivity of glasses which have been chemically strengthened and the waterdrop contact angle after forming an antifouling layer thereon and wearing the layer under certain conditions.

FIG. 3 is a diagram showing a relationship between the hopping frequency of glasses which have been chemically strengthened and the waterdrop contact angle after forming an antifouling layer thereon and wearing the layer under certain conditions.

FIG. 4 is a schematic plan view of an electrode pattern for measuring surface resistivity.

FIG. 5 is a schematic plan view of an electrode pattern used for surface resistivity measurement in Examples. In FIG. 5, the unit of the numerical value indicating the dimension of each width is mm.

FIG. 6 is a schematic view of an electrode pattern for use in impedance measurement.

### DESCRIPTION OF EMBODIMENTS

The glasses of the present invention are described in detail below, but the present invention is not limited to the following embodiments and can be modified at will within the gist of the present invention.

In this description, the term “chemically strengthened glass” means a glass which has undergone a chemical strengthening treatment. The term “glass for chemical strengthening” means a glass which has not undergone a chemical strengthening treatment.

In this description, the glass composition of a glass for chemical strengthening is sometimes called the base glass composition of a chemically strengthened glass. In chemically strengthened glasses, a compressive stress layer has usually been formed in glass surface portions by ion exchange and, hence, the portions which have not undergone the ion exchange have a glass composition that is identical with the base glass composition of the chemically strengthened glass.

In this description, the composition of each glass is expressed in mole percentage on an oxide basis, and “mol %” is often expressed simply by “%”. Furthermore, symbol “-” indicating a numerical range is used in the sense of including the numerical values set force before and after the “-” as a lower limit value and an upper limit value.

The expression “containing substantially no X” used for a glass composition means that the composition does not contain X except unavoidable impurity which was contained in a raw material, etc., that is, X has not been incorporated on purpose. Specifically, as for components except for a coloring component, the content thereof is, for example, less than 0.1 mol %.

In this description, “stress profile” is a pattern showing compressive stress values using the depth from a glass surface as a variable. Negative values of compressive stress mean tensile stress.

In this description, a “stress profile” can be determined by a method in which an optical-waveguide surface stress meter and a scattered-light photoelastic stress meter are used in combination.

With an optical-waveguide surface stress meter, the stress of a glass can be accurately measured in a short time period. As the optical-waveguide surface stress meter, there is, for example, FSM-6000, manufactured by Orihara Industrial Co., Ltd. However, because of the principle thereof, the optical-waveguide surface stress meter is usable in stress measurements only when the refractive index of a measurement sample decreases from the surface toward the inside. In a chemically strengthened glass, a layer obtained by replacing sodium ions inside the glass with external potassium ions is a layer in which the refractive index decreases from the sample surface toward the inside and, hence, the stress thereof can be measured with an optical-waveguide surface stress meter. However, the stress of a layer obtained by replacing lithium ions inside the glass with external sodium ions cannot be accurately measured with an optical-waveguide surface stress meter.

By a method employing a scattered-light photoelastic stress meter, stress can be measured regardless of a refractive-index distribution. As the scattered-light photoelastic stress meter, there is, for example, SLP1000, manufactured by Orihara Industrial Co., Ltd. However, the scattered-light photoelastic stress meter is apt to be affected by surface scattering, and there are cases where the stress of a portion near the surface cannot be accurately measured therewith.

For these reasons, an accurate stress measurement is rendered possible by using the two measuring devices, an optical-waveguide surface stress meter and a scattered-light photoelastic stress meter, in combination.

### <Glass>

### «Composition»

The glass according to this embodiment (hereinafter sometimes referred to as “present glass”) preferably is a lithium aluminosilicate glass including, in mole percentage on an oxide basis,

60-75% SiO₂,

8-20% Al₂O₃, and

5-16% Li₂O.

The preferred glass composition is explained below.

SiO₂ is a component which constitutes network of the glass. SiO₂ is also a component which enhances the chemical durability and is a component which makes the glass less apt to crack upon reception of surface flaws.

The content of SiO₂ is preferably 60% or more, more preferably 63% or more, especially preferably 65% or more. Meanwhile, from the standpoint of improving the meltability, the content of SiO₂ is preferably 75% or less, more preferably 72% or less, still more preferably 70% or less, especially preferably 68% or less.

Al₂O₃ is a component which improves the ion exchange performance in chemical strengthening and thereby enables the glass to have higher surface compressive stress after the strengthening.

The content of Al₂O₃ is preferably 8% or more, more preferably 9% or more, still more preferably 10% or more, yet still more preferably 11% or more, especially preferably 12% or more. Meanwhile, in case where the content of Al₂O₃ is too high, crystals are prone to grow during melting and this is apt to result in a decrease in yield due to devitrification defects. In addition, such a glass has increased high-temperature viscosity and is difficult to melt. The content of Al₂O₃ is preferably 20% or less, more preferably 18% or less, still more preferably 16% or less.

SiO₂ and Al₂O₃ are both components which stabilize the structure of the glass. From the standpoint of reducing the brittleness, the total content thereof is preferably 65% or more, more preferably 70% or more, still more preferably 75% or more.

SiO₂ and Al₂O₃ both tend to heighten the melting temperature of the glass. Because of this, from the standpoint of making the glass easy to melt, the total content thereof is preferably 90% or less, more preferably 87% or less, still more preferably 85% or less, especially preferably 82% or less.

Li₂O is a component which generates surface compressive stress through ion exchange, and is a component which improves the meltability of the glass. Since the chemically strengthened glass contains Li₂O, a stress profile indicating both a high surface compressive stress and a large compressive stress layer is obtained by a method in which Li ions in glass surfaces are replaced with external Na ions and Na ions are replaced with external K ions. From the standpoint of easily obtaining the preferred stress profile, the content of Li₂O is preferably 5% or more, more preferably 7% or more, still more preferably 9% or more, especially preferably 10% or more, most preferablyll% or more.

Meanwhile, in case where the content of Li₂O is too high, the glass has an increased rate of crystal growth during glass forming and this is apt to result in a decrease in quality due to devitrification. The content of Li₂O is preferably 20% or less, more preferably 16% or less, still more preferably 14% or less, especially preferably 12% or less.

Na₂O and K₂O, although each not essential, are components which improve the meltability of the glass and reduce the rate of crystal growth during glass forming. Also from the standpoint of improving ion exchange performance, it is preferable that Na₂O and K₂O are contained in a small amount.

Na₂O is a component which forms a surface compressive stress layer in a chemical strengthening treatment with a potassium salt, and is a component which lowers the viscosity of the glass. From the standpoint of obtaining these effects, the content of Na₂O is preferably 1% or more, more preferably 2% or more, still more preferably 3% or more, yet still more preferably 4% or more, especially preferably 5% or more. Meanwhile, from the standpoint of preventing a strengthening treatment with a sodium salt from resulting in a decrease in surface compressive stress (CS), the content of Na₂O is preferably 10% or less, more preferably 8% or less, still more preferably 6% or less, especially preferably 5% or less.

K₂O may be incorporated for the purpose of, for example, improving the ion exchange performance. The content of K₂O, when it is contained, is preferably 0.1% or more, more preferably 0.15% or more, especially preferably 0.2% or more. From the standpoint of effectively preventing devitrification, the content thereof is preferably 0.5% or more, more preferably 1.2% or more. Meanwhile, too high K₂O contents are prone to result in a decrease in the brittleness of the glass. In addition, too high K₂O contents sometimes lower the efficiency of chemical strengthening. The content of K₂O is preferably 5% or less, more preferably 3% or less, still more preferably 1% or less, especially preferably 0.5% or less.

The total content of Na₂O and K₂O ([Na₂O]+[K₂O]) is preferably 2-15%, and is more preferably 3% or more, still more preferably 4% or more. Meanwhile, the total content thereof is more preferably 10% or less, still more preferably 8% or less, yet still more preferably 6% or less, particularly preferably 5% or less, especially preferably 4% or less.

It is preferable that the content of Na₂O is higher than the content of K₂O. K₂O is prone to heighten the surface resistivity.

The content ratio represented by P_{Li}=[Li₂O]/([Li₂O]+[Na₂O]+[K₂O]) is preferably 0.40 or more, more preferably 0.50 or more, still more preferably 0.60 or more, from the standpoint of lowering the surface resistivity. Meanwhile, from the standpoint of inhibiting the glass from devitrifying when melted, that ratio is preferably 0.90 or less, especially preferably 0.80 or less.

The content ratio represented by P_{Na}=[Na₂O]/([Li₂O]+[Na₂O]+[K₂O]) is preferably 0.1 or more, more preferably 0.2 or more, from the standpoint of inhibiting devitrification. From the standpoint of lowering the surface resistivity, that ratio is preferably 0.5 or less, more preferably 0.4 or less.

The content ratio represented by P_{K}=[K₂O]/([Li₂O]+[Na₂O]+[K₂O]) is preferably 0.3 or less, more preferably 0.2 or less, from the standpoint of lowering the surface resistivity. There is no particular lower limit on that ratio, the ratio may be 0.

The content ratio represented by ([Al₂O₃]+[Li₂O])/([Na₂O]+[K₂O]+[MgO]+[CaO]+[SrO]+[BaO]+[ZnO]+[ZrO₂]+[Y₂O₃]) is preferably 5 or less, more preferably 4 or less, still more preferably 3.5 or less, especially preferably 3 or less, from the standpoint of reducing the rate of the growth of devitrification crystals.

From the standpoint of lowering the surface resistivity, the content ratio represented by [Al₂O₃]/([Li₂O]+[Na₂O]+[K₂O]) is preferably 0.6 or more, more preferably 0.7 or more, still more preferably 0.8 or more. Meanwhile, from the standpoint of improving the devitrification properties, that ratio is preferably 2 or less, more preferably 1.5 or less, still more preferably 1.2 or less.

From the standpoint of increasing the surface compressive stress to be generated by a chemical strengthening treatment with a sodium salt, the content ratio represented by ([Al₂O₃]+[Li₂O])/([Na₂O]+[K₂O]+[MgO]+[CaO]+[SrO]+[BaO]+[ZnO]+[ZrO₂]+[Y₂O₃]) is preferably 1 or more, more preferably 1.5 or more, still more preferably 2 or more.

MgO may be contained, for example, in order for the glass to have lowered viscosity when melted. The content of MgO is preferably 1% or more, more preferably 2% or more, still more preferably 3% or more. Meanwhile, too high MgO contents make it difficult to form a large compressive stress layer by a chemical strengthening treatment. The content of MgO is preferably 10% or less, more preferably 8% or less, especially preferably 6% or less.

In the case where MgO is contained, the total content thereof and SiO₂ and Al₂O₃, [SiO₂]+[Al₂O₃]+[MgO], is preferably 85% or less, more preferably 83% or less, still more preferably 82% or less, from the standpoint of regulating the viscosity during glass production.

Meanwhile, from the standpoint of reducing the brittleness of the glass, that total content is preferably 70% or more, more preferably 73% or more, still more preferably 75% or more.

MgO, CaO, SrO, BaO, and ZnO, although each not essential, may be contained from the standpoint of heightening the stability of the glass. The total content of these, [MgO]+[CaO]+[SrO]+[BaO]+[ZnO], is preferably 0.1% or more, more preferably 0.2% or more. From the standpoint of improving the brittleness of the glass, the total content thereof is preferably 10% or less, more preferably 5% or less, still more preferably 3% or less, yet still more preferably less than 1%.

From the standpoint of heightening the stability of the glass, it is preferable that at least one of MgO and CaO is contained and it is more preferable that MgO is contained. The total content of MgO and CaO is preferably 0.1% or more, more preferably 0.5% or more, still more preferably 1.0% or more. From the standpoint of enhancing properties to be imparted by chemical strengthening, the total content of MgO and CaO is preferably 3% or less, more preferably 2% or less.

ZnO, SrO, and BaO tend to impair the properties to be imparted by chemical strengthening. Hence, from the standpoint of facilitating chemical strengthening, the total content of these, [ZnO]+[SrO]+[BaO], is preferably 1.5% or less, more preferably 1.0% or less, still more preferably 0.5% or less. Meanwhile, from the standpoint of improving the brittleness of the glass, [ZnO]+[SrO]+[BaO] is preferably less than 1%. There is no particular lower limit on the total content, and none of these may be contained.

CaO is a component which improves the meltability of the glass, and may be contained. The content of CaO, when it is contained, is preferably 0.1% or more, more preferably 0.15% or more, still more preferably 0.5% or more. Meanwhile, too high CaO contents make it difficult to obtain a larger value of compressive stress by a chemical strengthening treatment. The content of CaO is preferably 5% or less, more preferably 3% or less, still more preferably 1% or less, yet still more preferably 0.5% or less.

SrO is a component which improves the meltability of the glass, and may be contained. The content of SrO, when it is contained, is preferably 0.1% or more, more preferably 0.15% or more, still more preferably 0.5% or more. Meanwhile, too high SrO contents make it difficult to obtain a larger value of compressive stress by a chemical strengthening treatment. The content of SrO is preferably 3% or less, more preferably 2% or less, still more preferably 1% or less, yet still more preferably 0.5% or less.

BaO is a component which improves the meltability of the glass, and may be contained. The content of BaO, when it is contained, is preferably 0.1% or more, more preferably 0.15% or more, still more preferably 0.5% or more. Meanwhile, too high BaO contents make it difficult to obtain a larger value of compressive stress by a chemical strengthening treatment. The content of BaO is preferably 3% or less, more preferably 2% or less, still more preferably 1% or less, yet still more preferably 0.5% or less.

ZnO is a component which improves the meltability of the glass, and may be contained. The content of ZnO, when it is contained, is preferably 0.1% or more, more preferably 0.15% or more, still more preferably 0.5% or more. Meanwhile, too high ZnO contents make it difficult to obtain a larger value of compressive stress by a chemical strengthening treatment. The content of ZnO is preferably 3% or less, more preferably 2% or less, still more preferably 1% or less, yet still more preferably 0.5% or less.

ZrO₂ may not be contained. However, it is preferable that ZrO₂ is contained, from the standpoint of enlarging surface compressive stress of a chemically strengthened glass. The content of ZrO₂ is preferably 0.1% or more, more preferably 0.15% or more, still more preferably 0.2% or more, yet still more preferably 0.25% or more, especially preferably 0.3% or more. Meanwhile, in case where the content of ZrO₂ is too high, devitrification defects are prone to occur and it is difficult to obtain a larger value of compressive stress by a chemical strengthening treatment. The content of ZrO₂ is preferably 2% or less, more preferably 1.5% or less, still more preferably 1% or less, especially preferably 0.8% or less.

Y₂O₃ is not essential. However, it is preferable that Y₂O₃ is contained, from the standpoint of lowering the rate of crystal growth while enabling the chemically strengthened glass to have an increased surface compressive stress.

From the standpoint of heightening the fracture toughness value, it is preferable that the glass composition contains one or more kinds of Y₂O₃, La₂O₃, and ZrO₂, in a total amount of 0.2% or more. The total content of Y₂O₃, La₂O₃, and ZrO₂ is preferably 0.5% or more, more preferably 1.0% or more, still more preferably 1.5% or more. Meanwhile, from the standpoint of lowering the liquidus temperature to inhibit devitrification, the total content thereof is preferably 8% or less, more preferably 6% or less, still more preferably 5% or less, yet still more preferably 4% or less.

From the standpoint of inhibiting devitrification, i.e., lowering the liquidus temperature, it is preferable that the total content of Y₂O₃ and La₂O₃ is higher than the content of ZrO₂, and it is more preferable that the content of Y₂O₃ is higher than the content of ZrO₂.

The content of Y₂O₃ is preferably 0.1% or more, more preferably 0.2% or more, still more preferably 0.5% or more, especially preferably 1% or more. Meanwhile, too high Y₂O₃ contents make it difficult to obtain a large compressive stress layer by a chemical strengthening treatment. The content of Y₂O₃ is preferably 5% or less, more preferably 3% or less, still more preferably 2% or less, especially preferably 1.5% or less.

La₂O₃, although not essential, can be contained for the same reason as in the case of Y₂O₃. The content of La₂O₃ is preferably 0.1% or more, more preferably 0.2% or more, still more preferably 0.5% or more, especially preferably 0.8% or more. Meanwhile, too high La₂O₃ contents make it difficult to obtain a large compressive stress layer by a chemical strengthening treatment. Hence, the content of La₂O₃ is preferably 5% or less, more preferably 3% or less, still more preferably 2% or less, especially preferably 1.5% or less.

TiO₂ is a component which is highly effective in inhibiting solarization of a glass, and may be contained. The content of TiO₂, when it is contained, is preferably 0.02% or more, more preferably 0.03% or more, still more preferably 0.04% or more, yet still more preferably 0.05% or more, especially preferably 0.06% or more. Meanwhile, from the standpoint of preventing the chemically strengthened glass from having reduced quality due to devitrification, the content of TiO₂ is preferably 1% or less, more preferably 0.5% or less, still more preferably 0.25% or less.

B₂O₃, although not essential, may be contained in order for the glass to have reduced brittleness and improved crack resistance or to have improved meltability. From the standpoint of reducing the brittleness, the content of B₂O₃ is preferably 0.5% or more, more preferably 1% or more, still more preferably 2% or more. Meanwhile, since too high B₂O₃ contents are prone to result in impaired acid resistance, the content of B₂O₃ is preferably 10% or less. The content of B₂O₃ is more preferably 6% or less, still more preferably 4% or less, especially preferably 2% or less. From the standpoint of preventing the occurrence of striae during melting, it is more preferable that the glass composition contains substantially no B₂O₃.

P₂O₅, although not essential, may be contained in order for the glass to come to have a large compressive stress layer through chemical strengthening. The content of P₂O₅, when it is contained, is preferably 0.5% or more, more preferably 1% or more, still more preferably 2% or more. Meanwhile, from the standpoint of enhancing the acid resistance, the content of P₂O₅ is preferably 6% or less, more preferably 4% or less, still more preferably 2% or less. From the standpoint of preventing the occurrence of striae during melting, it is more preferable that the glass composition contains substantially no P₂O₅.

The total content of B₂O₃ and P₂O₅ is preferably 0-10%, and is more preferably 1% or more, still more preferably 2% or more. The total content of B₂O₃ and P₂O₅ is more preferably 6% or less, still more preferably 4% or less.

Nb₂O₅, Ta₂O₅, Gd₂O₃, and CeO₂ are components which are effective in inhibiting solarization of a glass and which improve the meltability, and may be incorporated. In the case of incorporating these components, the content of each is preferably 0.03% or more, more preferably 0.1% or more, still more preferably 0.5% or more, yet still more preferably 0.8% or more, especially preferably 1% or more. Meanwhile, since too high contents thereof make it difficult to obtain an increased value of compressive stress by a chemical strengthening treatment, the contents of those components are each preferably 3% or less, more preferably 2% or less, still more preferably 1% or less, especially preferably 0.5% or less.

Fe₂O₃ absorbs heat rays and is hence effective in improving the meltability of the glass. In the case of mass-producing the glass using a large melting furnace, it is preferable that the glass composition contains Fe₂O₃. In this case, the content thereof, in terms of wt% on an oxide basis, is preferably 0.002% or more, more preferably 0.005% or more, still more preferably 0.007% or more, especially preferably 0.01% or more. Meanwhile, in case where Fe₂O₃ is contained in excess, coloration occurs. Consequently, from the standpoint of enhancing the transparency of the glass, the content thereof, in terms of wt% on an oxide basis, is preferably 0.3% or less, more preferably 0.04% or less, still more preferably 0.025% or less, especially preferably 0.015% or less.

The explanation given above was made on iron oxides in the glass which were all regarded as Fe₂O₃. Actually, however, Fe is normally present as a mixture of Fe(III), which is in an oxidized state, and Fe(II), which is in a reduced state. Fe(III) causes yellow coloration and Fe(II) causes blue coloration, and a balance therebetween makes the glass have green coloration.

Other coloring components may be further added so long as the addition thereof does not inhibit the attainment of desired properties to be imparted by chemical strengthening. Suitable examples of the other coloring components include Co₃O₄, MnO₂, NiO, CuO, Cr₂O₃, V₂O₅, Bi₂O₃, SeO₂, CeO₂, Er₂O₃, and Nd₂O₃.

The content of such coloring components including Fe₂O₃ is preferably 5% or less in total in mole percentage on an oxide basis. Contents thereof exceeding 5% sometimes make the glass prone to devitrify. The content of the coloring components is preferably 3% or less, more preferably 1% or less. In the case where it is desired to heighten the transmittance of the glass, it is preferable to contain substantially none of these components.

The glass composition may suitably contain SO₃, a chloride, a fluoride, etc. as a refining agent for glass melting. It is preferable that no As₂O₃ is contained. In cases when Sb₂O₃ is contained, the content thereof is preferably 0.3% or less, more preferably 0.1% or less. It is most preferable that no Sb₂O₃ is contained.

The present glass preferably has a value of parameter X, which is determined with the following expression from the contents (mol %) of components, of 0.70 or more. This is because the present glass having such value of X is less apt to fracture vigorously. The value of X is more preferably 0.75 or more, still more preferably 0.80 or more, especially preferably 0.83 or more, and is usually 1.5 or less.

X=0.00866×[SiO₂]+0.00724×[Al₂O₃]+0.00526×[MgO]+0.00444×[CaO]+0.00797×[ZnO]+0.0122×[ZrO₂]+0.0172×[Y₂O₃]+0.009×[Li₂O]+0.00163×[Na₂O]−0.00384×[K₂O]

### «Peel Resistance of Antifouling Layer»

The present inventors made an investigation on the peel resistance of an antifouling layer which was a layer of a fluorine-containing organic compound formed on surfaces of chemically strengthened glasses. As a result, the inventors have discovered that there is a correlation between the surface resistivities of the chemically strengthened glasses and the peel resistance of the antifouling layer.

The peel resistance of an antifouling layer can be evaluated by a method in which the antifouling layer is formed on a glass surface, subsequently subjected to “frictional abrasion with a rubber eraser”, and then examined for contact angle with a waterdrop. The larger the contact angle with water after the frictional abrasion with a rubber eraser, the more the function of the antifouling layer is retained and the better the peel resistance thereof.

Specifically, the peel resistance of the antifouling layer can be evaluated by subjecting the antifouling layer to frictional abrasion with a rubber eraser and then measuring the contact angle thereof with a waterdrop, for example, by the following methods.

(Frictional Abrasion with Rubber Eraser)

A cylindrical rubber eraser having a diameter of 6 mm is attached to an abrasion tester, and the surface of the antifouling layer is worn by 7,500-stroke abrasion under the conditions of a load of 1 kgf, a stroke width of 40 mm, a speed of 40 rpm, 25° C., and 50% RH.

(Measurement of Contact Angle with Water)

A drop of about 1 μL of pure water is placed on the surface Na which has undergone the frictional abrasion with the rubber eraser, and the contact angle between the water and the glass, i.e., contact angle with water, is measured using a contact angle meter. The larger the contact angle with water after the frictional abrasion, the better the peel resistance of the antifouling layer.

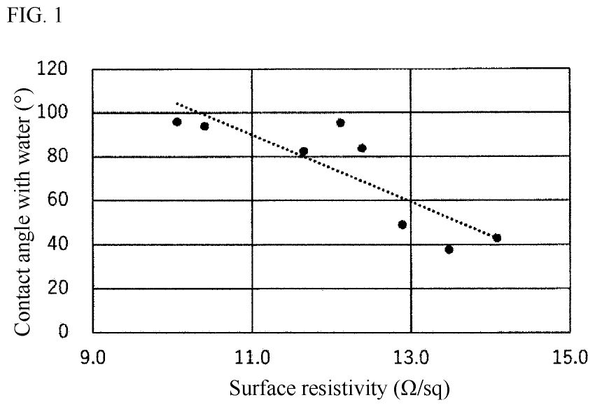

FIG. 1 is a diagram showing a relationship in glass sheets which have not been chemically strengthened, between the surface resistivity measured by the method which will be described later and the contact angle with water measured after the frictional abrasion with the rubber eraser by the method described above. FIG. 1 shows a tendency that the lower the surface resistivity, the larger the contact angle with water and the better the peel resistance of the antifouling layer.

### «Hopping Frequency»

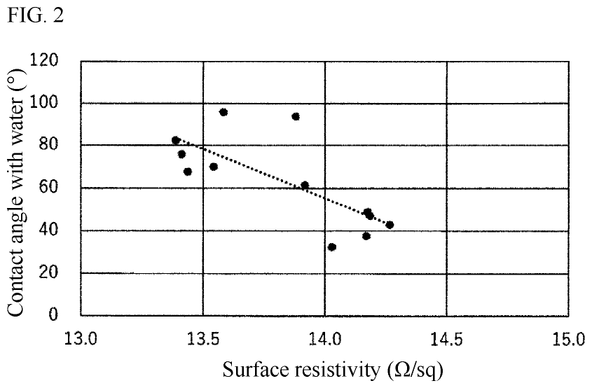

FIG. 2 is a diagram likewise showing a relationship in chemically strengthened glasses between the surface resistivity and the peel resistance, i.e., adhesion, of an antifouling layer. As in FIG. 1, there is a tendency that the lower the surface resistivity, the larger the contact angle with water and the better the adhesion of the antifouling layer. It is, however, noted that the correlation between the surface resistivity and the adhesion of the antifouling layer is less clear than that in the glasses which have not been chemically strengthened.

The present inventors examine the difference as follows.

The adhesion of the antifouling layer depends on the charging properties of the glass, and the charging properties of the glass depend on the movability of charges from the glass surface, in other words, the electrical conductivity of the glass surface. The surface resistivity, i.e., electrical conductivity, of the glass depends on the kinds and amounts of alkali components present in the glass surface.

Meanwhile, the adhesion of the antifouling layer and the charging properties of the glass are affected not only by the electrical conductivity of the glass surface but also by the electrical conductivity of an inner portion of the glass. In the chemically strengthened glass, the alkali components present in the glass surface differ from the alkali components present in the inner portion of the glass, due to the influence of the ion exchange treatment. Because of this, the surface and the inner portion of the glass differ in electrical conductivity, resulting in a lessened correlation between the surface resistivity of the glass and the peel resistance of the antifouling layer.

The adhesion of an antifouling layer is frequently evaluated by a frictional abrasion test with a rubber eraser. It is thought to be appropriate that the charging caused by friction with a rubber eraser is evaluated with alternating current rather than direct current.

The present inventors investigated an admittance model of a capacitance element in an alternating-current circuit and thought that the complex admittance of the glass, rather than direct-current surface resistance value, should be examined in examining the adhesion of the antifouling layer.

With respect to complex admittance Y* (ω) regarding ion-conductive materials, the following model formula, which is called the Almond-West formula, is known as a variable of frequency ω (reference document: Journal of Materials Science, vol. 19, 1984, 3236-3248).

[Math. 1]

Y*(ω)=A₁ωⁿ^{₁}+A₂ωⁿ^{₁}+i(B₁ωⁿ^{₁}+B₂ωⁿ^{₂})+iωC_{∞} (13)

A₁, B₁, A₂, and B₂ are as follows.

[Math. 2]

A₁=Kωₚ¹⁻ⁿ^{₁} (14)

B₁=A₁ tan(n₁π/2) (15)

A₂=Kωₚ¹⁻ⁿ^{₂} (16)

B₂=A₂ tan(n₂π/2) (17)

The present inventors made the following examination from the relational formula.

The complex admittance of a glass is expressed with constants K, n₁, n₂, and C_{∞} and hopping frequency ωₚ. It is hence thought that the charging properties of the glass depend on the hopping frequency and that the glass is made less chargeable by increasing the hopping frequency.

The hopping frequency is determined by measuring the complex admittance of the glass sheet using an impedance analyzer and fitting the complex admittance with formula (13) (Almond-West formula) described above.

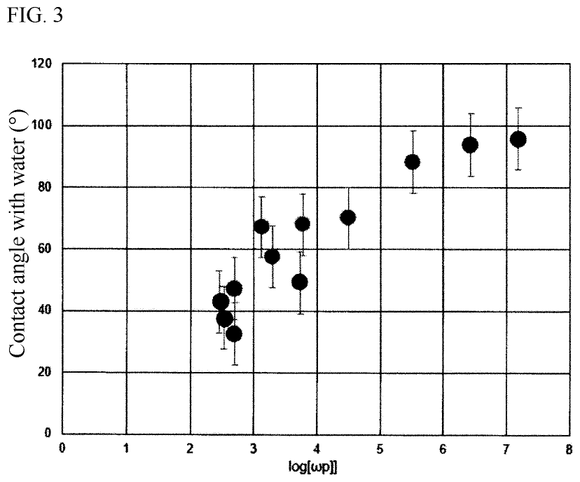

FIG. 3 is a diagram showing a relationship in chemically strengthened glasses between the hopping frequency measured by the method which will be described later and the contact angle with water after frictional abrasion with a rubber eraser measured by the method described above. FIG. 3 shows a tendency that the higher the hopping frequency, the larger the contact angle with water and the better the peel resistance of the antifouling layer.

In glasses which have not been chemically strengthened, there is a linear relationship between the surface resistivity and the hopping frequency and, hence, the hopping frequency correlates with the peel resistance of the antifouling layer.

A chemically strengthened glass according to this embodiment (hereinafter sometimes abbreviated to “present chemically strengthened glass”) obtained by chemically strengthening the present glass is less apt to be charged when having a hopping frequency, as determined by the following method, of 10^{2.8} Hz or more, preferably 10^{3.0} Hz or more, more preferably 10^{3.5} Hz or more. However, glasses having too high hopping frequencies tend to devitrify or to have small a fracture toughness value. The hopping frequency of the present chemically strengthened glass is preferably 10^{6.0} Hz or less, more preferably 10^{5.5} Hz or less, still more preferably 10^{5.0} Hz or less.

### (Method for Determining Hopping Frequency)

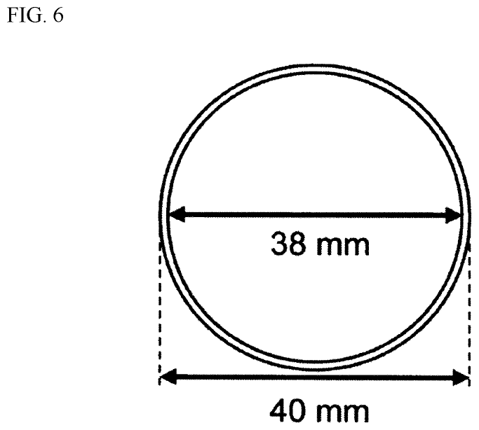

A glass sheet is processed into a sheet shape having dimensions of 50 mm×50 mm×0.7 mm, and the electrode pattern shown in FIG. 6 is formed on one surface thereof.

An impedance analyzer is used to measure the impedance in the frequency range of 20 MHz to 2 MHz to determine the complex admittance.

### «Entropy Function»

The present inventors have further discovered that in glasses which have not been chemically strengthened, the surface resistivity depends on an entropy function S. The present glass has a small value of the entropy function S represented by the following expression (sometimes abbreviated to “S value”) and, hence, has a low surface resistivity and is excellent in terms of the peel resistance of antifouling layers.

S=−P_{Li}×log(P_{Li})−P_{Na}×log(P_{Na})−Pₖ×log(P_{K})

in which

P_{Li}=[Li₂O]/([Li₂O]+[Na₂O]+[K₂O])

P_{Na}=[Na₂O]/([Li₂O]+[Na₂O]+[K₂O])

P_{K}=[K₂O]/([Li₂O]+[Na₂O]+[K₂O]),

provided that [Li₂O], [Na₂O], and [K₂O] respectively indicate the contents, in mole percentage on an oxide basis, of Li₂O, Na₂O, and K₂O. Hereinafter, the contents of other components are sometimes expressed likewise.

The S value of the present glass is preferably 0.37 or less, more preferably 0.35 or less, still more preferably 0.3 or less, yet still more preferably 0.28 or less. Although there is no particular lower limit thereon, the S value is usually 0.15 or more.

It is preferable that the present glass, after having been chemically strengthened, has a base glass composition which has a value of S that is within that range of the S value of the present glass.

### «Surface Resistivity»

The present glass in an unstrengthened state has a surface resistivity at 50° C. of preferably 10¹³ Ω/sq or less, more preferably 10^{12.5} Ω/sq or less, still more preferably 10¹² Ω/sq or less, from the standpoint of reducing the charge amount on the glass surface. Meanwhile, since glasses having a small charge amount tend to have poor devitrification properties during production, the surface resistivity at 50° C. of the present glass is, for example, preferably 10⁸ Ω/sq or more, more preferably 10^{8.5} Ω/sq or more, still more preferably 10⁹ Ω/sq or more.

The present glass, after having been chemically strengthened, has a surface resistivity at 50° C. of preferably 10¹⁵ Ω/sq or less, more preferably 10^{14.5} Ω/sq or less, still more preferably 10¹⁴ Ω/sq or less, especially preferably 10^{13.5} Ω/sq or less, most preferably 10¹³ Ω/sq or less, from the standpoint of reducing the charge amount on the glass surface. The surface resistivity thereof is, for example, 10⁸ Ω/sq or more, preferably 10^{8.5} Ω/sq or more, more preferably 10⁹ Ω/sq or more, especially preferably 10^{10.5} Ω/sq or more, most preferably 10¹¹ Ω/sq or more.

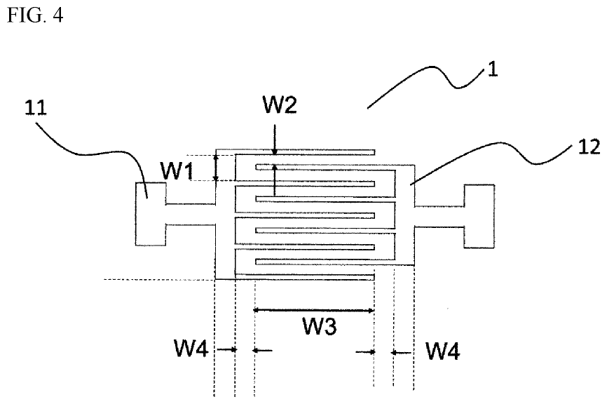

Surface resistivity can be measured by the method which will be described later in Examples. In FIG. 4 is shown a schematic plan view of comb-shaped electrodes 1 for use in surface resistivity measurements. In FIG. 4, the comb-shaped electrodes 1 have such a shape that a first comb-shaped electrode 11 and a second comb-shaped electrode 12 have been disposed opposite each other so that the teeth of one comb shape are engaged with those of the other.

The surface resistivity p is determined from a resistance value R, which is determined using R=V/I from a current value I and a voltage V both measured using the comb-shaped electrodes, and from an electrode coefficient r using ρ=R×r. The electrode coefficient r is calculated from a ratio between electrode length and electrode-to-electrode distance on each side. With respect to the comb-shaped electrodes 1 of FIG. 4, the electrode coefficient r is calculated using r=(W3/W2)×8+(W1/W4)×7. The electrode coefficient r of the comb-shaped electrodes 1 is, for example, 100-130.

As a metal for constituting the comb-shaped electrodes 1, use is made of a material having low electrical resistance, such as platinum, aluminum, or gold. Platinum is preferred as the metal for constituting the comb-shaped electrodes 1. The comb-shaped electrodes 1 are formed, for example, by preparing an electrically insulating substrate and forming a film of a metal for constituting the comb-shaped electrodes on the substrate by a means such as sputtering, vacuum deposition, plating, etc.

### «Fracture Toughness Value»

The present glass has a fracture toughness value K1c of preferably 0.70 MPa·m^{½} or more, more preferably 0.75 MPa·m^{½} or more, still more preferably 0.80 MPa·m^{½} or more, especially preferably 0.83 MPa·m^{½} or more. Meanwhile, the fracture toughness value thereof is usually 2.0 MPa·m^{½} or less, typically 1.5 MPa·m^{½} or less. Such high fracture toughness values render the glass less apt to fracture vigorously even after a high surface compressive stress is introduced thereinto by chemical strengthening.

Fracture toughness value can be measured, for example, using a DCDC method (Acta metall. mater, Vol. 43, pp. 3453-3458, 1995).

The present glass has a β-OH value of preferably 0.1 mm⁻¹ or more, more preferably 0.15 mm⁻¹ or more, still more preferably 0.2 mm⁻¹ or more, especially preferably 0.22 mm⁻¹ or more, most preferably 0.25 mm⁻¹ or more.

β-OH value is an index to the water content of glass. Glasses having large β-OH values tend to have lowered softening points and be easy to bend. Meanwhile, from the standpoint of improving the strength of a glass by chemical strengthening, too large β-OH values make the strength improvement difficult since a glass having too large a β-OH value gives a chemically strengthened glass having a reduced value of surface compressive stress (CS). Because of this, the β-OH value is preferably 0.5 mm⁻¹ or less, more preferably 0.4 mm⁻¹ or less, still more preferably 0.3 mm⁻¹ or less.

The present glass has a Young's modulus of preferably 80 GPa or more, more preferably 82 GPa or more, still more preferably 84 GPa or more, especially preferably 85 GPa or more, from the standpoint of rendering the glass less apt to fracture. There is no particular upper limit on the Young's modulus thereof. However, since glasses having high Young's moduli sometimes have reduced acid resistance, the Young's modulus of the present glass is, for example, 110 GPa or less, preferably 100 GPa or less, more preferably 90 GPa or less. Young's modulus can be measured, for example, by an ultrasonic pulse method.

The present glass has a density of preferably 3.0 g/cm³ or less, more preferably 2.8 g/cm³ or less, still more preferably 2.6 g/cm³ or less, especially preferably 2.55 g/cm³ or less, from the standpoint of reducing the weight of products. There is no particular lower limit on the density thereof. However, since glasses having low densities tend to be low in acid resistance, etc., the density of the present glass is, for example, 2.3 g/cm³ or more, preferably 2.4 g/cm³ or more, especially preferably 2.45 g/cm³ or more.

The present glass has a refractive index of preferably 1.6 or less, more preferably 1.58 or less, still more preferably 1.56 or less, especially preferably 1.54 or less, from the standpoint of diminishing the surface reflection of visible light. There is no particular lower limit on the refractive index of the present glass. However, since glasses having low refractive indexes tend to have low acid resistance, the refractive index of the present glass is, for example, 1.5 or more, preferably 1.51 or more, more preferably 1.52 or more.

The present glass has a photoelastic coefficient of preferably 33 nm/cm/MPa or less, more preferably 32 nm/cm/MPa or less, still more preferably 31 nm/cm/MPa or less, especially preferably 30 nm/cm/MPa or less, from the standpoint of reducing optical strain. Meanwhile, since glasses having low photoelastic coefficients tend to have low acid resistance, the photoelastic coefficient of the present glass is, for example, 24 nm/cm/MPa or more, more preferably 25 nm/cm/MPa or more, still more preferably 26 nm/cm/MPa or more.

The present glass has an average coefficient of linear thermal expansion (coefficient of thermal expansion) at 50-350° C. of preferably 95×10⁻⁷/° C. or less, more preferably 90×10⁻⁷/° C. or less, still more preferably 88×10⁻⁷/° C. or less, especially preferably 86×10⁻⁷/° C. or less, most preferably 84×10⁻⁷/° C. or less, from the standpoint of inhibiting the glass from warping through chemical strengthening. There is no particular lower limit on the coefficient of thermal expansion thereof. However, since glasses having low coefficients of thermal expansion are sometimes difficult to melt, the average coefficient of linear thermal expansion (coefficient of thermal expansion) at 50-350° C. of the present glass is, for example, 60×10⁻⁷/° C. or more, preferably 70×10⁻⁷/° C. or more, more preferably 74×10⁻⁷/° C. or more, still more preferably 76×10⁻⁷/° C. or more.

The glass transition point (Tg) is preferably 500° C. or more, more preferably 520° C. or more, still more preferably 540° C. or more, from the standpoint of inhibiting the glass from warping through chemical strengthening. From the standpoint of rendering the glass easy to form by a float process, the glass transition point is preferably 750° C. or less, more preferably 700° C. or less, still more preferably 650° C. or less, especially preferably 600° C. or less, most preferably 580° C. or less.

The temperature (T2) at which the viscosity is 10² dPa·s is preferably 1,750° C. or less, more preferably 1,700° C. or less, still more preferably 1,675° C. or less, especially preferably 1,650° C. or less. The temperature (T2) is a measure of temperatures for melting the glass, and there is a tendency that the lower the T2, the easier the production of the glass. There is no particular lower limit on the T2. However, since glasses low in T2 tend to have too low glass transition points, the T2 is usually 1,400° C. or more, preferably 1,450° C. or more.

The temperature (T4) at which the viscosity is 10⁴ dPa·s is preferably 1,350° C. or less, more preferably 1,300° C. or less, still more preferably 1,250° C. or less, especially preferably 1,150° C. or less. The temperature (T4) is a measure of temperatures for forming the glass into a sheet shape, and glasses high in T4 tend to impose a larger burden on the forming apparatus. There is no particular lower limit on the T4. However, since glasses low in T4 tend to have too low glass transition points, the T4 is usually 900° C. or more, preferably 950° C. or more, more preferably 1,000° C. or more.

The present glass preferably has a devitrification temperature which is not higher than a temperature higher by 120° C. than the temperature (T4) at which the viscosity is 10⁴ dPa·s, because the glass having such devitrification temperature is less apt to devitrify when formed by a float process. The devitrification temperature thereof is more preferably not higher than a temperature higher than T4 by 100° C., still more preferably not higher than a temperature higher than T4 by 50° C., especially preferably not higher than T4.

The present glass has a softening point of preferably 850° C. or less, more preferably 820° C. or less, still more preferably 790° C. or less. This is because the lower the softening point of a glass, the lower the heat treatment temperature in bending to result in less energy consumption and a smaller burden on the equipment. The lower the softening point, the more the glass is preferred from the standpoint of bending the glass at lower temperatures. However, ordinary glasses have softening points of 700° C. or more. Since glasses having too low softening points tend to have low strength because the stress to be introduced by a chemical strengthening treatment is prone to relax. The softening point thereof is hence preferably 700° C. or more. The softening point thereof is more preferably 720° C. or more, still more preferably 740° C. or more. Softening point can be measured by the fiber elongation method described in JIS R3103-1:2001.

The present glass preferably has a crystallization peak temperature higher than [softening point]−100° C., the crystallization peak temperature being determined by the following method. It is more preferable that no crystallization peak is observed.

The crystallization peak temperature is determined by crushing about 70 mg of the glass, grinding the crushed glass with an agate mortar, and examining the resultant glass powder with a differential scanning calorimeter (DSC) while heating the glass powder from room temperature to 1,000° C. at a heating rate of 10° C./min.

The glass according to this embodiment can be produced by an ordinary method. For example, raw materials for the components of the glass are mixed and the mixture is heated and melted with a glass melting furnace. Thereafter, the glass is homogenized by a known method, formed into a desired shape, e.g., a glass sheet, and annealed.

Examples of methods for forming the glass into a glass sheet include a float process, pressing process, a fusion process, and a downdraw process. The float process is especially preferred because it is suitable for mass production. Continuous processes other than the float process such as a fusion process and a downdraw process are also preferred.

Thereafter, the formed glass is ground and polished according to need to form a glass substrate. In cases when the glass substrate is to be cut into a given shape and size or is to be chamfered, it is preferred to perform the cutting or chamfering of the glass substrate before the chemical strengthening treatment which will be described later is given thereto. This is because a compressive stress layer is formed also in the end surfaces by the subsequent chemical strengthening treatment.

### <Chemically Strengthened Glass>

The present chemically strengthened glass has a base glass composition which is the same as the glass composition of the glass described above. The present chemically strengthened glass has a surface compressive stress value of preferably 600 MPa or more, more preferably 700 MPa or more, still more preferably 800 MPa or more.

The present chemically strengthened glass can be produced by subjecting the obtained glass sheet to a chemical strengthening treatment and then cleaning and drying the treated glass sheet.

The chemical strengthening treatment can be conducted by a known method. In the chemical strengthening treatment, the glass sheet is brought into contact, for example by immersion, with a melt of a metal salt (e.g., potassium nitrate) containing metal ions having a large ionic radius (typically, K ions). Thus, metal ions having a small ionic radius (typically, Na ions or Li ions) in the glass sheet are replaced by metal ions having a large ionic radius (typically, K ions for replacing Na ions, or Na or K ions for replacing Li ions).

The chemical strengthening treatment, i.e., ion exchange treatment, can be carried out, for example, by immersing the glass sheet for 0.1-500 hours in a molten salt, e.g., potassium nitrate, heated to 360-600° C. The heating temperature of the molten salt is preferably 375° C. or more and is preferably 500° C. or less. The period of immersion of the glass sheet in the molten salt is preferably 0.3 hours or more and is preferably 200 hours or less.

Examples of the molten salt for conducting the chemical strengthening treatment include nitrates, sulfates, carbonates, and chlorides. Examples of the nitrates include lithium nitrate, sodium nitrate, potassium nitrate, cesium nitrate, and silver nitrate. Examples of the sulfates include lithium sulfate, sodium sulfate, potassium sulfate, cesium sulfate, and silver sulfate. Examples of the carbonates include lithium carbonate, sodium carbonate, and potassium carbonate. Examples of the chlorides include lithium chloride, sodium chloride, potassium chloride, cesium chloride, and silver chloride. One of these molten salts may be used alone, or two or more thereof may be used in combination.

Treatment conditions for the chemical strengthening treatment in this embodiment may be suitably selected while taking account of the properties and composition of the glass, kind of the molten salt, desired properties, such as surface compressive stress and a depth of compressive stress layer, which are to be imparted by the chemical strengthening to the chemically strengthened glass to be finally obtained, etc.

In this embodiment, a chemical strengthening treatment may be conducted only once, or a plurality of chemical strengthening treatments (multistage strengthening) may be conducted under two or more different sets of conditions. For example, a chemical strengthening treatment is conducted as a first-stage chemical strengthening treatment under such conditions as to result in a large DOL and a relatively low CS. Thereafter, a chemical strengthening treatment is conducted as a second-stage chemical strengthening treatment under such conditions as to result in a small DOL and a relatively high CS. Thus, the chemically strengthened glass can have a heightened outermost-surface CS and be inhibited from having a large internal tensile stress area (St), and can have a reduced internal tensile stress (CT).

It is preferable that a layer of a fluorine-containing organic compound is disposed on at least a part of the surfaces of the present chemically strengthened glass. The disposition of the layer of a fluorine-containing organic compound improves the antifouling properties and the finger slipperiness. Examples of the fluorine-containing organic compound include silane compounds containing a perfluoro(poly)ether group. The thickness of the organic-compound layer is preferably 0.1 nm or more and is preferably 1,000 nm or less.

In the case where the present glass is a sheet-shaped glass sheet, the sheet thickness (t) thereof is, for example, 2 mm or less, preferably 1.5 mm or less, more preferably 1 mm or less, still more preferably 0.9 mm or less, especially preferably 0.8 mm or less, most preferably 0.7 mm or less, from the standpoint of heightening the effect of chemical strengthening. Meanwhile, from the standpoint of sufficiently obtaining the strength-improving effect of a chemical strengthening treatment, the sheet thickness is, for example, 0.1 mm or more, preferably 0.2 mm or more, more preferably 0.4 mm or more, still more preferably 0.5 mm or more.

The present glass may have any of shapes other than sheet shapes, in accordance with products, uses, etc. to which the glass is applied. The glass sheet may have, for example, a trimmed shape in which the periphery has different thicknesses. Configurations of the glass sheet are not limited to these. For example, the two principal surfaces may not be parallel with each other, or a part or all of one or each of the two principal surfaces may be a curved surface. More specifically, the glass sheet may be, for example, a flat glass sheet having no warpage or may be a curved glass sheet having curved surfaces.

The present glass and the present chemically strengthened glass, which is obtained by chemically strengthening the glass, are useful, for example, as cover glasses. The present glass and the present chemically strengthened glass are useful especially as cover glasses for use in mobile appliances such as portable telephones, smartphones, portable digital assistants (PDAs), and tablet devices. Furthermore, the present glass and the present chemically strengthened glass are useful as the cover glasses of display devices not intended to be carried, such as televisions (TVs), personal computers (PCs), and touch panels, and also in applications such as elevator wall surfaces, wall surfaces (overall displays) of houses, buildings, and the like, building materials such as window glasses, table tops, interior trims for motor vehicles, air planes, etc., and cover glasses for these. Moreover, the present glass and the present chemically strengthened glass are useful in applications such as housings having a curved shape, which is not flat, formed by bending or forming.

### EXAMPLES

The present invention is described below by reference to Examples, but the present invention is not limited by the following Examples. G1 to G44 and G49 to G66 are Working Examples, and G45 to G48 are Comparative Examples. S1 to S7, S9 to S14, and S17 to S22 are Working Examples, and S8, S15, and S16 are Comparative Examples. With respect to the examination results in the tables, each “-” indicates that the property was not evaluated.

### (Preparation of Glasses for Chemical Strengthening and of Chemically Strengthened Glasses)

Glass sheets were prepared through melting with a platinum crucible so as to result in the glass compositions shown in mole percentage on an oxide basis in Tables 1 to 5. Raw materials for glass were suitably selected from among general raw materials including oxides, hydroxides, carbonates, and nitrates, and weighted out so as to result in 1,000 g each of glasses. Subsequently, each mixture of raw materials was put in a platinum crucible, which was introduced into a resistance-heating electric furnace heated at 1,500-1,700° C. to melt, defoam, and homogenize the contents for about 3 hours. The obtained molten glasses were each poured into a mold, held at a temperature of [glass transition point]+50° C. for 1 hour, and then cooled to room temperature at a rate of 0.5° C./min to obtain a glass block. The obtained glass blocks were each cut and ground, and both surfaces were finally mirror-polished to obtain a sheet-shaped glass having dimensions of 50 mm (length)×50 mm (width)×0.7 mm (sheet thickness) as a glass for chemical strengthening.

Properties of the obtained glasses for chemical strengthening were evaluated in the following manners. The results thereof are shown in Tables 1 to 5. In Tables 1 to 5, the numerical values given as bold-faced italics are estimates calculated from the glass compositions.

### <Entropy Function>

Entropy function S value was calculated from the contents of Li₂O, Na₂O, and K₂O.

### <Density>

Density was calculated from a value measured by a submerged weighing method (JIS Z8807:2012; Method for Measuring Density and Specific Gravity of Solids) and from the glass composition. The unit is g/cm³; density is expressed by “d” in the tables.

### <Young's Modulus>

A glass which had not been chemically strengthened was examined for Young's modulus (E) (unit; GPa) by an ultrasonic pulse method (JIS R1602:1995).

### <Average Coefficient of Linear Thermal Expansion a and Glass Transition Point (Tg)>

An average coefficient of linear expansion within the temperature range of 50-350° C. (α₅₀₋₃₅₀) (unit; 10⁻⁷/° C.) and a glass transition point were calculated from a value measured in accordance with JIS R3102:1995 “Test Method for Average Coefficient of Linear Expansion of Glass” and from the glass composition. The average coefficient and the glass transition point are expressed by “α” and “Tg”, respectively, in the tables.

### <T2, T4>

With respect to a glass which had not been chemically strengthened, T2 and T4 were calculated from values of temperatures T2 and T4 at which the glass had viscosities of 10² dPa·s and 10⁴ dPa·s, respectively, that were measured with a rotational viscometer (according to ASTM C 965-96) and from the glass composition. The T2 and the T4 are expressed by “Tlogη=2” and “Tlogη=4”, respectively, in the tables.

### <Fracture Toughness Value K1c>

The fracture toughness value K1c of a glass which had not been chemically strengthened was measured by a DCDC method (Acta metall. mater., Vol. 43, pp. 3453-3458, 1995) using Autograph (AGS-X, manufactured by SHIMAZU Corp.) and a camera for observation. Estimates were calculated from values obtained by the measurement and from glass compositions.

### <Devitrification Propagation Rate>

The rate of crystal growth which occurred due to devitrification was determined in the following manner.

Glass pieces were ground with a mortar and classified, and glass particles which had passed through a 3.35-mm-mesh sieve but had not passed through a 2.36-mm-mesh sieve were washed with ion-exchanged water and dried. The dried glass particles were used in the test.

The glass particles were placed on a slender platinum cell having a large number of recesses, so that each recess contained one glass particle. This platinum cell was heated in an electric furnace having a temperature of 1,000-1,100° C. until the surface of each glass particle melted and became smooth.

Subsequently, the glass was introduced into a temperature-gradient furnace kept at given temperatures and was heat-treated for a certain time period (expressed by t hours), and was then taken out into a room-temperature environment and allowed to cool rapidly. By this method, a large number of glass particles can be simultaneously heat-treated by disposing a slender vessel in the temperature-gradient furnace.

The heat-treated glass was examined with a polarizing microscope (ECLIPSE LV100ND, manufactured by Nikon Corp.) and the diameter (expressed by L μm) of the largest of observed crystals was measured. This examination was made under the conditions of an ocular lens magnification of 10 times, an objective lens magnification of 5-100 times, transmitted light, and polarized-light examination. Since a crystal generated by devitrification can be regarded as growing isotropically, the rate of devitrification propagation (crystal growth) is L/(2t) [unit: μm/h]

However, the crystals to be examined were selected from among ones which had not precipitated from the boundary between the glass and the container. This is because the propagation of devitrification at the boundary between a glass and a metal tends to show behavior different from that of the general propagation of devitrification occurring within the glass or at the glass-atmosphere boundary.

### <Liquidus Temperature>

Particles of a crushed glass were placed on a platinum dish and heat-treated for 17 hours in an electric furnace regulated so as to have a constant temperature. The heat-treated glass was examined with a polarizing microscope and evaluated for devitrification to estimate a devitrification temperature. For example, if the expression “1325-1350” is given in a table, this means that the glass was devitrified by a 1,325° C. heat treatment but was not devitrified by a 1,350° C. heat treatment. In this case, the devitrification temperature was 1,325° C. or more but less than 1,350° C.

### <Surface Resistivity>

(Substrate Cleaning)

A glass substrate was cleaned for 5 minutes with an alkaline detergent obtained by mixing 4 mass % sodium metasilicate nonahydrate, 20 mass % polyoxyethylene alkyl ether, and pure water, subsequently cleaned with a neutral detergent for 5 minutes, cleaned with room-temperature pure water, 50° C. pure water, and 65° C. pure water for 5 minutes each, and then dried by blowing 65° C. hot air against the substrate surfaces for 6 minutes.

(Preparation for Measurement)

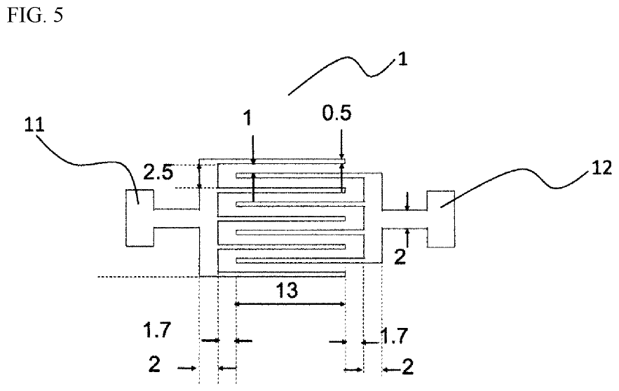

A Pt film was deposited in a thickness of 30 nm on a surface of the glass substrate (50 mm×50 mm) using a magnetron sputtering coater (Q300TT, manufactured by Quorum Techbiologies Ltd.) in an Ar atmosphere to prepare the pattern of comb-shaped electrodes shown in FIG. 5. In FIG. 5, the unit of the numerical value indicating the dimension of each width is mm.

(Measurement)

A measurement was made using a digital ultrahigh-resistance/microammeter (ADVANTEST R830A ULTRA HIGH RESISTANCE METER).

The glass sheet was placed on a copper substrate and copper wires were connected to the obtained electrodes. Thereafter, this assembly was heated to 50° C. and allowed to stand still for 30 minutes until the temperature became stable. After the temperature stabilization, a voltage of 50 V was applied thereto and the assembly was kept in this state for 3 minutes until the voltage became stable. The current measurement was then initiated and the current value at 3 minutes thereafter was read. A surface resistivity (Ω/sq) was calculated using the relational expression described hereinabove. In the tables, the surface resistivity is shown in terms of the logarithm thereof.

### <Hopping Frequency>

An electrode pattern of the shape shown in FIG. 6 was formed by a method in which a ring having an inner diameter of 38 mm, an outer diameter of 40 mm, and a width of 1 mm was placed on a surface of a glass substrate (50 mm×50 mm×0.7 mm) and sputtering was performed. This glass substrate specimen was examined for complex admittance by the method described hereinabove using an impedance analyzer (Precision LCR Meter E4980A; 16451B dielectric test fixture; and accessory electrode A manufactured by Keysight Technologies, Inc.). The obtained value of complex admittance was fitted with the Almond-West formula to calculate a hopping frequency (Hz).

In the Examples, K, n₁, n₂, and C₂₈ were assumed to be substantially constant values depending on the thickness of the glass sheet. Specifically, assuming that K=−11.214, n₁=0.995, n₂=0.576, and C_{∞}=20.726, the hopping frequency (bp was calculated from the obtained complex admittance using the Almond-West formula. In the tables, the hopping frequency ωp is shown in terms of the logarithm thereof.

### <Peel Resistance of Antifouling Layer>

An antifouling layer was formed on a surface of a glass sheet (5 cm×5 cm) in the following manner, and this glass sheet was subjected to frictional abrasion with a rubber eraser and then to a measurement of contact angle with water.

(Formation of Antifouling Layer)

The glass sheet which had been washed with water was further cleaned with a plasma, and a fluorine-containing organic compound (UD-509, manufactured by Daikin Ltd.) was thereafter vacuum-deposited thereon by a method of vacuum deposition with resistance heating. The pressure inside the vacuum chamber during the deposition was regulated to 3.0×10⁻³ Pa and the deposition was conducted for 300 seconds at a deposition output of 318.5 kA/m². The obtained antifouling layer had a thickness of 15 nm.

(Test of Frictional Abrasion with Rubber Eraser)

Using a flat-surface abrasion tester (triple type) (device name: PA-300A, manufactured by Daiei Kagaku Seiki Mfg. Co., Ltd.), the surface of the antifouling layer was worn by 7,500-stroke abrasion with a rubber eraser having a diameter of 6 mm (Pink Pencil, manufactured by WOOJIN) under the conditions of a load of 1 kgf, a stroke width of 40 mm, a speed of 40 rpm, 25° C., and 50% RH. Thereafter, the surface of the antifouling layer was examined for contact angle with water.

(Measurement of Contact Angle with Water)

A drop of about 1 μL pure water was placed on the surface of the antifouling layer, and the contact angle (°) with the water was measured using a contact angle meter.

### <β-OH>

As an index to the water content of a glass which had not been chemically strengthened, the value of β-OH was determined using an FT-IR spectrometer (Nicolet iS10, manufactured by ThermoFisher Scientific).

TABLE 1

| (mol %) | G1 | G2 | G3 | G4 | G5 | G6 | G7 | G8 | G9 | G10 |
|---|---|---|---|---|---|---|---|---|---|---|
| SiO₂ | 63.7 | 68.0 | 64.7 | 64.7 | 63.7 | 63.7 | 66.7 | 65.2 | 67.7 | 66.2 |
| Al₂O₃ | 16.0 | 13.0 | 16.0 | 16.0 | 16.0 | 16.0 | 14.0 | 14.0 | 13.0 | 14.0 |
| Li₂O | 11.0 | 11.5 | 10.5 | 10.0 | 11.0 | 11.0 | 11.0 | 11.0 | 11.0 | 10.0 |
| Na₂O | 4.0 | 4.8 | 4.0 | 4.0 | 4.0 | 4.0 | 4.0 | 6.0 | 6.0 | 5.0 |
| K₂O | 0.0 | 0.0 | 0.0 | 0.0 | 0.0 | 0.0 | 0.0 | 0.0 | 0.0 | 0.0 |
| Y₂O₃ | 4.0 | 2.0 | 3.7 | 4.5 | 2.5 | 3.0 | 2.0 | 2.5 | 1.0 | 3.0 |
| ZrO₂ | 1.0 | 0.5 | 0.8 | 1.0 | 2.5 | 2.0 | 2.0 | 1.0 | 1.0 | 1.5 |
| TiO₂ | 0.1 | 0.1 | 0.0 | 0.0 | 0.0 | 0.0 | 0.0 | 0.0 | 0.0 | 0.0 |
| CeO₂ | 0.0 | 0.0 | 0.0 | 0.0 | 0.0 | 0.0 | 0.0 | 0.0 | 0.0 | 0.0 |
| MgO | 0.0 | 0.0 | 0.0 | 0.0 | 0.0 | 0.0 | 0.0 | 0.0 | 0.0 | 0.0 |
| CaO | 0.2 | 0.2 | 0.2 | 0.2 | 0.2 | 0.2 | 0.2 | 0.2 | 0.2 | 0.2 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 | 0.0 |
| Na₂O + K₂O | 4.0 | 4.8 | 4.0 | 4.0 | 4.0 | 4.0 | 4.0 | 6.0 | 6.0 | 5.0 |
| P_{Li} (Li₂O/R₂O) | 0.73 | 0.71 | 0.72 | 0.71 | 0.73 | 0.73 | 0.73 | 0.65 | 0.65 | 0.67 |
| Y₂O₃ + ZrO₂ | 5.0 | 2.5 | 4.5 | 5.5 | 5.0 | 5.0 | 4.0 | 3.5 | 2.0 | 4.5 |
| Entropy function | [symbol] | [symbol] | [symbol] | [symbol] | [symbol] | [symbol] | [symbol] | [symbol] | [symbol] | [symbol] |
| d | [symbol] | [symbol] | [symbol] | [symbol] | [symbol] | [symbol] | [symbol] | [symbol] | [symbol] | [symbol] |
| α | [symbol] | [symbol] | [symbol] | [symbol] | [symbol] | [symbol] | [symbol] | [symbol] | [symbol] | [symbol] |
| Tg | [symbol] | [symbol] | [symbol] | [symbol] | [symbol] | [symbol] | [symbol] | [symbol] | [symbol] | [symbol] |
| E | [symbol] | [symbol] | [symbol] | [symbol] | [symbol] | [symbol] | [symbol] | [symbol] | [symbol] | [symbol] |
| Tlogη = 2 | [symbol] | [symbol] | [symbol] | [symbol] | [symbol] | [symbol] | [symbol] | [symbol] | [symbol] | [symbol] |
| Tlogη = 4 | [symbol] | [symbol] | [symbol] | [symbol] | [symbol] | [symbol] | [symbol] | [symbol] | [symbol] | [symbol] |
| K1c | [symbol] | [symbol] | [symbol] | [symbol] | [symbol] | [symbol] | [symbol] | [symbol] | [symbol] | [symbol] |
| Logarithm of surface | [symbol] | 12.1 | [symbol] | [symbol] | [symbol] | [symbol] | [symbol] | [symbol] | [symbol] | [symbol] |
| resistivity (Ω/sq) | | | | | | | | | | |
| Logarithm of surface | — | 13.8 | — | — | — | — | — | — | — | — |
| resistivity (Ω/sq) after | | | | | | | | | | |
| strengthening | | | | | | | | | | |
| Logarithm of hopping | — | — | — | — | — | — | — | — | — | — |
| frequency, logωp | | | | | | | | | | |
| Peel resistance of | — | 102 | — | — | — | — | — | — | — | — |
| antifouling layer; | | | | | | | | | | |
| contact angle (°) | | | | | | | | | | |
| Rate of devitrification | [symbol] | 4000 | [symbol] | [symbol] | [symbol] | [symbol] | [symbol] | [symbol] | [symbol] | [symbol] |
| propagation (μm/hour) | | | | | | | | | | |
| Liquidus temperature | 1325-1350 | 1275-1300 | — | — | — | — | — | — | 1275 or | — |
| (° C.) | | | | | | | | | less | |
| β-OH (mm⁻¹) | — | 0.24 | — | — | — | — | — | — | — | — |

TABLE 2

| (mol %) | G11 | G12 | G13 | G14 | G15 | G16 | G17 | G18 | G19 | G20 |
|---|---|---|---|---|---|---|---|---|---|---|
| SiO | 66.2 | 68.7 | 68.7 | 68.0 | 65.0 | 65.0 | 68.0 | 67.0 | 67.0 | 68.0 |
| Al₂O₃ | 14.5 | 11.2 | 12.8 | 14.0 | 14.0 | 14.0 | 13.5 | 14.0 | 14.0 | 13.0 |
| Li₂O | 10.0 | 11.0 | 11.0 | 10.5 | 10.5 | 10.5 | 10.5 | 10.5 | 10.5 | 9.0 |
| Na₂O | 5.0 | 4.0 | 4.0 | 4.8 | 7.8 | 4.8 | 4.8 | 4.8 | 4.8 | 7.3 |
| K₂O | 0.0 | 0.0 | 0.0 | 0.0 | 0.0 | 0.0 | 0.0 | 0.0 | 0.0 | 0.0 |
| Y₂O₃ | 3.0 | 4.0 | 0.8 | 2.0 | 2.0 | 2.0 | 2.5 | 2.0 | 2.0 | 2.0 |
| ZrO₂ | 1.0 | 0.8 | 2.4 | 0.5 | 0.5 | 0.5 | 0.5 | 0.5 | 0.5 | 0.5 |
| TiO₂ | 0.0 | 0.0 | 0.0 | 0.0 | 0.0 | 0.0 | 0.0 | 0.0 | 0.0 | 0.0 |
| CeO₂ | 0.0 | 0.0 | 0.0 | 0.0 | 0.0 | 0.0 | 0.0 | 1.0 | 0.0 | 0.0 |
| MgO | 0.0 | 0.0 | 0.0 | 0.0 | 0.0 | 3.0 | 0.0 | 0.0 | 0.0 | 0.0 |
| CaO | 0.2 | 0.2 | 0.2 | 0.2 | 0.2 | 0.2 | 0.2 | 0.2 | 0.2 | 0.2 |
| SrO | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 1.0 | 0.0 |
| B₂O₃ | 0.0 | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 | 0.0 |
| Na₂O + K₂O | 5.0 | 4.0 | 4.0 | 4.8 | 7.8 | 4.8 | 4.8 | 4.8 | 4.8 | 7.3 |
| P_{Li} (Li₂O/R₂O) | 0.67 | 0.73 | 0.73 | 0.69 | 0.57 | 0.69 | 0.69 | 0.69 | 0.69 | 0.55 |
| Y₂O₃ + ZrO₂ | 4.0 | 4.8 | 3.2 | 2.5 | 2.5 | 2.5 | 3.0 | 2.5 | 2.5 | 2.5 |
| Entropy function | 0.28 | 0.25 | 0.25 | 0.27 | 0.30 | 0.27 | 0.27 | 0.27 | 0.27 | 0.30 |
| d | [symbol] | [symbol] | [symbol] | [symbol] | [symbol] | [symbol] | [symbol] | — | — | [symbol] |
| α | [symbol] | [symbol] | [symbol] | [symbol] | [symbol] | [symbol] | [symbol] | — | — | [symbol] |
| Tg | [symbol] | [symbol] | [symbol] | [symbol] | [symbol] | [symbol] | [symbol] | — | — | [symbol] |
| E | [symbol] | [symbol] | [symbol] | [symbol] | [symbol] | [symbol] | [symbol] | — | — | [symbol] |
| Tlogη = 2 | [symbol] | [symbol] | | [symbol] | [symbol] | [symbol] | [symbol] | — | — | [symbol] |
| Tlogη = 4 | [symbol] | [symbol] | [symbol] | [symbol] | [symbol] | [symbol] | [symbol] | — | — | [symbol] |
| K1c | [symbol] | [symbol] | [symbol] | [symbol] | [symbol] | [symbol] | [symbol] | — | — | [symbol] |
| Logarithm of surface | [symbol] | 12.2 | [symbol] | 12.0 | 12.7 | 12.4 | [symbol] | [symbol] | [symbol] | [symbol] |
| resistivity (Ω/sq) | | | | | | | | | | |
| Logarithm of hopping | — | 4.4 | — | — | — | — | — | — | — | — |
| frequency, logωp | | | | | | | | | | |
| Peel resistance of | — | 95 | — | — | — | — | — | — | — | — |
| antifouling layer; | | | | | | | | | | |
| contact angle (°) | | | | | | | | | | |
| Rate of devitrification | [symbol] | [symbol] | [symbol] | [symbol] | [symbol] | [symbol] | [symbol] | [symbol] | [symbol] | [symbol] |
| propagation (μm/hour) | | | | | | | | | | |
| Liquidus temperature | 1325-1350 | 1350° C. | — | 1300-1325 | 1250-1275 | 1250-1275 | — | 1275-1300 | 1250-1275 | — |
| (° C.) | | or more | | | | | | | | |
| β-OH (mm⁻¹) | — | — | — | — | — | — | — | — | — | — |

TABLE 3

| (mol %) | G21 | G22 | G23 | G24 | G25 | G26 | G27 | G28 | G29 | G30 | G31 | G32 | G33 | G34 |
|---|---|---|---|---|---|---|---|---|---|---|---|---|---|---|
| SiO₂ | 68.0 | 67.7 | 68.9 | 69.2 | 68.0 | 68.0 | 68.2 | 67.7 | 69.6 | 67.0 | 68.4 | 67.4 | 67.9 | 67.7 |
| Al₂O₃ | 13.0 | 13.0 | 13.0 | 13.0 | 13.0 | 13.0 | 13.2 | 13.0 | 12.5 | 14.0 | 12.5 | 12.5 | 13.0 | 13.0 |
| Li₂O | 13.5 | 11.0 | 11.5 | 10.7 | 9.2 | 10.7 | 12.0 | 11.5 | 13.3 | 8.2 | 12.2 | 12.9 | 11.5 | 11.5 |
| Na₂O | 2.8 | 4.3 | 4.8 | 4.4 | 3.8 | 2.3 | 3.9 | 4.8 | 3.0 | 8.1 | 5.1 | 5.4 | 4.8 | 4.8 |
| K₂O | 0.0 | 0.0 | 0.0 | 0.0 | 0.0 | 0.0 | 0.0 | 0.3 | 0.0 | 0.0 | 0.0 | 0.0 | 0.1 | 0.3 |
| Y₂O₃ | 2.0 | 2.0 | 1.3 | 2.0 | 2.0 | 2.0 | 2.0 | 2.0 | 1.3 | 2.0 | 1.3 | 1.3 | 2.0 | 2.0 |
| ZrO₂ | 0.5 | 0.5 | 0.3 | 0.5 | 0.5 | 0.5 | 0.5 | 0.5 | 0.3 | 0.5 | 0.3 | 0.3 | 0.5 | 0.5 |
| TiO₂ | 0.00 | 0.00 | 0.00 | 0.00 | 0.00 | 0.00 | 0.00 | 0.12 | 0.00 | 0.00 | 0.00 | 0.00 | 0.00 | 0.00 |
| MgO | 0.0 | 1.5 | 0.0 | 0.0 | 3.3 | 3.3 | 0.0 | 0.0 | 0.0 | 0.0 | 0.0 | 0.0 | 0.0 | 0.0 |
| CaO | 0.2 | 0.0 | 0.2 | 0.2 | 0.2 | 0.2 | 0.2 | 0.2 | 0.0 | 0.2 | 0.2 | 0.2 | 0.2 | 0.2 |
| SrO | 0.0 | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 | 0.0 | 0.0 | 0.0 | 0.0 | 0.0 |
| Na₂O + K₂O | 2.8 | 4.3 | 4.8 | 4.4 | 3.8 | 2.3 | 3.9 | 5.1 | 3.0 | 8.1 | 5.1 | 5.4 | 4.9 | 5.1 |
| P_{Li} (Li₂O/R₂O) | 0.83 | 0.72 | 0.71 | 0.71 | 0.71 | 0.82 | 0.75 | 0.69 | 0.82 | 0.50 | 0.71 | 0.71 | 0.70 | 0.69 |
| Y₂O₃ + ZrO₂ | 2.5 | 2.5 | 1.6 | 2.5 | 2.5 | 2.5 | 2.5 | 2.5 | 1.6 | 2.5 | 1.6 | 1.6 | 2.5 | 2.5 |
| Entropy function | 0.20 | 0.26 | 0.26 | 0.26 | 0.26 | 0.20 | 0.24 | 0.27 | 0.21 | 0.30 | 0.26 | 0.26 | 0.28 | 0.30 |
| d | [symbol] | [symbol] | [symbol] | [symbol] | [symbol] | [symbol] | [symbol] | [symbol] | [symbol] | [symbol] | [symbol] | [symbol] | [symbol] | [symbol] |
| α | [symbol] | [symbol] | [symbol] | [symbol] | [symbol] | [symbol] | [symbol] | [symbol] | [symbol] | [symbol] | [symbol] | [symbol] | [symbol] | [symbol] |
| Tg | [symbol] | [symbol] | [symbol] | [symbol] | [symbol] | [symbol] | [symbol] | [symbol] | [symbol] | [symbol] | [symbol] | [symbol] | [symbol] | [symbol] |
| E | [symbol] | [symbol] | [symbol] | [symbol] | [symbol] | [symbol] | [symbol] | [symbol] | [symbol] | [symbol] | [symbol] | [symbol] | [symbol] | [symbol] |
| Tlogη = 2 | [symbol] | [symbol] | [symbol] | [symbol] | [symbol] | [symbol] | [symbol] | [symbol] | [symbol] | [symbol] | [symbol] | [symbol] | [symbol] | [symbol] |
| Tlogη = 4 | [symbol] | [symbol] | [symbol] | [symbol] | [symbol] | [symbol] | [symbol] | [symbol] | [symbol] | [symbol] | [symbol] | [symbol] | [symbol] | [symbol] |
| K1c | [symbol] | [symbol] | [symbol] | [symbol] | [symbol] | [symbol] | [symbol] | [symbol] | [symbol] | [symbol] | [symbol] | [symbol] | [symbol] | [symbol] |
| Logarithm of surface resistivity (Ω/sq) | [symbol] | [symbol] | 12.0 | 12.1 | 12.3 | 12.1 | 11.8 | 12.1 | [symbol] | [symbol] | [symbol] | [symbol] | [symbol] | [symbol] |
| Logarithm of hopping frequency, logωp | — | — | — | — | — | — | — | — | — | — | — | — | — | — |
| Peel resistance of antifouling layer; | — | — | — | — | — | — | 105 | 101 | 107 | — | — | — | 92 | 89 |
| contact angle (°) | | | | | | | | | | | | | | |
| Rate of devitrification propagation | [symbol] | [symbol] | [symbol] | [symbol] | [symbol] | [symbol] | [symbol] | 3900 | [symbol] | [symbol] | [symbol] | [symbol] | [symbol] | [symbol] |
| (μm/hour) | | | | | | | | | | | | | | |
| Liquidus temperature (° C.) | — | — | — | — | — | — | — | 1250-1260 | — | — | — | — | — | — |
| β-OH (mm⁻¹) | — | — | — | — | — | — | — | 0.30 | — | — | — | — | — | — |

TABLE 4

| (mol %) | G35 | G36 | G37 | G38 | G39 | G40 | G41 | G42 | G43 | G44 | G45 | G46 | G47 | G48 |
|---|---|---|---|---|---|---|---|---|---|---|---|---|---|---|
| SiO₂ | 68.9 | 68.9 | 69.4 | 68.2 | 67.7 | 69.4 | 69.4 | 69.4 | 69.4 | 72.2 | 66.2 | 63.0 | 53.6 | 64.0 |
| Al₂O₃ | 12.5 | 12.5 | 12.0 | 12.9 | 13.4 | 12.5 | 12.5 | 12.5 | 12.5 | 10.0 | 11.2 | 16.0 | 32.1 | 12.0 |
| Li₂O | 11.5 | 11.5 | 11.5 | 11.5 | 11.5 | 11.5 | 11.5 | 11.5 | 11.5 | 12.0 | 10.4 | 6.3 | 10.7 | 16.0 |
| Na₂O | 4.8 | 5.3 | 5.3 | 4.8 | 4.8 | 4.8 | 4.8 | 4.8 | 4.8 | 5.5 | 5.6 | 11.0 | 0.0 | 0.0 |
| K₂O | 0.0 | 0.0 | 0.0 | 0.3 | 0.3 | 0.0 | 0.0 | 0.0 | 0.0 | 0.0 | 1.5 | 0.0 | 0.0 | 0.0 |
| Y₂O₃ | 1.8 | 1.3 | 1.3 | 1.3 | 1.3 | 1.6 | 1.5 | 1.2 | 1.1 | 0.0 | 0.5 | 0.0 | 3.6 | 0.0 |
| ZrO₂ | 0.3 | 0.3 | 0.3 | 0.3 | 0.3 | 0.0 | 0.0 | 0.3 | 0.5 | 0.0 | 1.3 | 0.0 | 0.0 | 2 |
| TiO₂ | 0.03 | 0.03 | 0.03 | 0.03 | 0.03 | 0.03 | 0.12 | 0.12 | 0.03 | 0.12 | 0.12 | 0.00 | 0.00 | 0.00 |
| MgO | 0.0 | 0.0 | 0.0 | 0.6 | 0.6 | 0.0 | 0.0 | 0.0 | 0.0 | 0.0 | 3.1 | 0.0 | 0.0 | 6 |
| CaO | 0.2 | 0.2 | 0.2 | 0.2 | 0.2 | 0.2 | 0.2 | 0.2 | 0.2 | 0.2 | 0.2 | 0.0 | 0.0 | 0.0 |
| SrO | 0.0 | 0.0 | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 | 0.0 | 0.0 | 1.1 | 0.0 | 0.0 |
| La₂O₃ | 0.0 | 0.0 | 0.0 | 0.0 | 0.0 | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 | 0.0 | 0.0 | 2.5 | 0.0 | 0.0 |
| Na₂O + K₂O | 4.8 | 5.3 | 5.3 | 5.0 | 5.0 | 4.8 | 4.8 | 4.8 | 4.8 | 5.5 | 7.1 | 11.0 | 0.0 | 0.0 |
| P_{Li} (Li₂O/R₂O) | 0.71 | 0.68 | 0.68 | 0.70 | 0.70 | 0.71 | 0.71 | 0.71 | 0.71 | 0.69 | 0.59 | 0.36 | 1.00 | 1.00 |
| Y₂O₃ + ZrO₂ | 2.1 | 1.6 | 1.6 | 1.6 | 1.6 | 1.6 | 1.5 | 1.5 | 1.6 | 0.0 | 1.8 | 0.0 | 3.6 | 2.0 |
| Entropy function | 0.26 | 0.27 | 0.27 | 0.27 | 0.27 | 0.26 | 0.26 | 0.26 | 0.26 | 0.27 | 0.38 | 0.29 | 0 | 0 |
| d | [symbol] | [symbol] | [symbol] | [symbol] | [symbol] | [symbol] | [symbol] | [symbol] | [symbol] | [symbol] | [symbol] | [symbol] | [symbol] | [symbol] |
| α | [symbol] | [symbol] | [symbol] | [symbol] | [symbol] | [symbol] | [symbol] | [symbol] | [symbol] | [symbol] | [symbol] | [symbol] | — | [symbol] |
| Tg | [symbol] | [symbol] | [symbol] | [symbol] | [symbol] | [symbol] | [symbol] | [symbol] | [symbol] | [symbol] | [symbol] | [symbol] | — | [symbol] |
| E | [symbol] | [symbol] | [symbol] | [symbol] | [symbol] | [symbol] | [symbol] | [symbol] | [symbol] | [symbol] | [symbol] | [symbol] | 105 | [symbol] |
| Tlogη = 2 | [symbol] | [symbol] | [symbol] | [symbol] | [symbol] | [symbol] | [symbol] | [symbol] | [symbol] | [symbol] | [symbol] | [symbol] | — | [symbol] |
| Tlogη = 4 | [symbol] | [symbol] | [symbol] | [symbol] | [symbol] | [symbol] | [symbol] | [symbol] | [symbol] | [symbol] | [symbol] | [symbol] | — | [symbol] |
| K1c | [symbol] | [symbol] | [symbol] | [symbol] | [symbol] | [symbol] | [symbol] | [symbol] | [symbol] | [symbol] | [symbol] | [symbol] | 0.97 | [symbol] |
| Logarithm of surface resistivity (Ω/sq) | [symbol] | [symbol] | [symbol] | [symbol] | [symbol] | [symbol] | [symbol] | [symbol] | [symbol] | [symbol] | 13.6 | 11.7 | [symbol] | [symbol] |
| Logarithm of surface resistivity (Ω/sq) | — | — | — | — | — | — | — | — | — | — | 14.2 | 13.4 | — | — |
| after strengthening | | | | | | | | | | | | | | |
| Logarithm of hopping frequency, logωp | — | — | — | — | — | — | — | — | — | — | 2.7 | 5.0 | — | — |
| Peel resistance of antifouling layer; | — | — | — | — | — | — | — | — | — | — | 71 | 104 | — | — |
| contact angle (°) | | | | | | | | | | | | | | |
| Rate of devitrification propagation | [symbol] | [symbol] | [symbol] | [symbol] | [symbol] | [symbol] | [symbol] | [symbol] | [symbol] | [symbol] | 400 | [symbol] | [symbol] | [symbol] |
| (μm/hour) | | | | | | | | | | | | | | |
| Liquidus temperature (° C.) | — | — | — | — | — | — | — | — | — | 1100-1150 | 1120-1130 | 1030-1040 | 1550° C. | 1340-1360 |
| β-OH (mm⁻¹) | — | — | — | — | — | — | — | — | — | — | 0.30 | — | — | — |

TABLE 5

| (mol %) | G49 | G50 | G51 | G52 | G53 | G54 | G55 | G56 | G57 |
|---|---|---|---|---|---|---|---|---|---|
| SiO₂ | 68.7 | 68.7 | 69.1 | 68.9 | 68.3 | 68.9 | 69.0 | 69.0 | 69.0 |
| Al₂O₃ | 12.4 | 12.9 | 12.4 | 12.4 | 12.4 | 12.2 | 12.4 | 11.8 | 12.0 |
| Li₂O | 10.9 | 11.4 | 11.5 | 11.4 | 12.0 | 11.2 | 11.4 | 11.4 | 11.4 |
| Na₂O | 4.6 | 4.8 | 4.8 | 4.8 | 1.5 | 4.7 | 4.8 | 4.8 | 4.8 |
| K₂O | 0.3 | 0.3 | 0.3 | 0.6 | 3.0 | 0.7 | 0.6 | 1.2 | 1.0 |
| Y₂O₃ | 2.0 | 0.8 | 0.8 | 1.3 | 1.5 | 1.3 | 1.3 | 1.3 | 1.3 |
| ZrO₂ | 0.3 | 0.3 | 0.3 | 0.3 | 0.5 | 0.3 | 0.3 | 0.3 | 0.3 |
| TiO₂ | 0.03 | 0.12 | 0.12 | 0.03 | 0.12 | 0.12 | 0.12 | 0.12 | 0.12 |
| MgO | 0.6 | 0.6 | 0.6 | 0.1 | 0.6 | 0.6 | 0.1 | 0.1 | 0.1 |
| CaO | 0.2 | 0.2 | 0.2 | 0.2 | 0.2 | 0.1 | 0.1 | 0.1 | 0.1 |
| SrO | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 |
| Na₂O + K₂O | 4.9 | 5.1 | 5.1 | 5.4 | 4.5 | 5.4 | 5.4 | 6.0 | 5.8 |
| P_{Li} (Li₂O/R₂O) | 0.69 | 0.69 | 0.69 | 0.68 | 0.73 | 0.67 | 0.68 | 0.66 | 0.66 |
| Y₂O₃ + ZrO₂ | 2.3 | 1.1 | 1.1 | 1.6 | 2.0 | 1.6 | 1.6 | 1.6 | 1.6 |
| Entropy | 0.30 | 0.30 | 0.30 | 0.32 | 0.33 | 0.33 | 0.32 | 0.35 | 0.34 |
| function | | | | | | | | | |
| d | [symbol] | [symbol] | [symbol] | [symbol] | [symbol] | [symbol] | [symbol] | [symbol] | [symbol] |
| α | [symbol] | [symbol] | [symbol] | [symbol] | [symbol] | [symbol] | [symbol] | [symbol] | [symbol] |
| Tg | [symbol] | [symbol] | [symbol] | [symbol] | [symbol] | [symbol] | [symbol] | [symbol] | [symbol] |
| E | [symbol] | [symbol] | [symbol] | [symbol] | [symbol] | [symbol] | [symbol] | [symbol] | [symbol] |
| Tlogη = 2 | [symbol] | [symbol] | [symbol] | [symbol] | [symbol] | [symbol] | [symbol] | [symbol] | [symbol] |
| Tlogη = 4 | [symbol] | [symbol] | [symbol] | [symbol] | [symbol] | [symbol] | [symbol] | [symbol] | [symbol] |
| K1c | [symbol] | [symbol] | [symbol] | [symbol] | [symbol] | [symbol] | [symbol] | [symbol] | [symbol] |
| Logarithm | [symbol] | [symbol] | [symbol] | [symbol] | [symbol] | [symbol] | [symbol] | [symbol] | [symbol] |
| of surface | | | | | | | | | |
| resistivity | | | | | | | | | |
| (Ω/sq) | | | | | | | | | |
| Logarithm | — | — | — | — | — | — | — | — | — |
| of surface | | | | | | | | | |
| resistivity | | | | | | | | | |
| (Ω/sq) after | | | | | | | | | |
| strengthening | | | | | | | | | |
| Logarithm | — | — | — | — | — | — | — | — | — |
| of hopping | | | | | | | | | |
| frequency, | | | | | | | | | |
| logωp | | | | | | | | | |
| Peel resistance | — | — | — | — | — | — | — | — | — |
| of antifouling | | | | | | | | | |
| layer; contact | | | | | | | | | |
| angle (°) | | | | | | | | | |
| Rate of | [symbol] | [symbol] | [symbol] | [symbol] | [symbol] | [symbol] | [symbol] | [symbol] | [symbol] |
| devitrification | | | | | | | | | |
| propagation | | | | | | | | | |
| (μm/hour) | | | | | | | | | |
| Liquidus | — | — | — | — | — | — | — | — | — |
| temperature | | | | | | | | | |
| (° C.) | | | | | | | | | |
| β-OH (mm⁻¹) | — | — | — | — | — | — | — | — | — |
| (mol %) | G58 | G59 | G60 | G61 | G62 | G63 | G64 | G65 | G66 |
| SiO₂ | 69.0 | 69.0 | 69.2 | 68.3 | 65.8 | 69.24 | 69.1 | 68.76 | 68.4 |
| Al₂O₃ | 12.2 | 12.4 | 12.4 | 10.4 | 12.4 | 12.5 | 12.4 | 12.4 | 12.3 |
| Li₂O | 11.4 | 11.4 | 10.6 | 10.1 | 11.4 | 11.5 | 11.4 | 11.4 | 11.3 |
| Na₂O | 4.8 | 4.8 | 4.7 | 3.9 | 4.8 | 4.8 | 4.8 | 4.8 | 4.7 |
| K₂O | 0.8 | 0.6 | 1.2 | 1.2 | 0.3 | 0.07 | 0.14 | 0.29 | 0.43 |
| Y₂O₃ | 1.3 | 1.3 | 1.3 | 1.3 | 1.3 | 1.3 | 1.3 | 1.3 | 1.3 |
| ZrO₂ | 0.3 | 0.3 | 0.3 | 0.3 | 0.3 | 0.3 | 0.3 | 0.3 | 0.4 |
| TiO₂ | 0.12 | 0.12 | 0.12 | 0.12 | 0.12 | 0.115 | 0.032 | 0.115 | 0.032 |
| MgO | 0.1 | 0.1 | 0.1 | 4.4 | 3.6 | 0.2 | 0.3 | 0.6 | 0.9 |
| CaO | 0.1 | 0.1 | 0.1 | 0.2 | 0.1 | 0.1 | 0.2 | 0.1 | 0.2 |
| SrO | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 |
| ZnO | 0.0 | 0.0 | 0.0 | 0.0 | 0.0 | 0.0 | 0.0 | 0.0 | 0.0 |
| La₂O₃ | 0.0 | 0.0 | 0.0 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 |
| P₂O₅ | 0.0 | 0.0 | 0.0 | 0.0 | 0.0 | 0.0 | 0.0 | 0.0 | 0.0 |
| Na₂O + K₂O | 5.6 | 5.4 | 5.9 | 5.0 | 5.1 | 4.9 | 4.9 | 5.1 | 5.1 |
| P_{Li} (Li₂O/R₂O) | 0.67 | 0.68 | 0.64 | 0.67 | 0.69 | 0.70 | 0.70 | 0.69 | 0.69 |
| Y₂O₃ + ZrO₂ | 1.6 | 1.6 | 1.6 | 1.6 | 1.6 | 1.6 | 1.6 | 1.6 | 1.7 |
| Entropy | 0.33 | 0.32 | 0.36 | 0.35 | 0.30 | 0.26 | 0.27 | 0.27 | 0.27 |
| function | | | | | | | | | |
| d | [symbol] | [symbol] | [symbol] | [symbol] | [symbol] | [symbol] | [symbol] | [symbol] | [symbol] |
| α | [symbol] | [symbol] | [symbol] | [symbol] | [symbol] | [symbol] | [symbol] | [symbol] | [symbol] |
| Tg | [symbol] | [symbol] | [symbol] | [symbol] | [symbol] | [symbol] | [symbol] | [symbol] | [symbol] |
| E | [symbol] | [symbol] | [symbol] | [symbol] | [symbol] | [symbol] | [symbol] | [symbol] | [symbol] |
| Tlogη = 2 | [symbol] | [symbol] | [symbol] | [symbol] | [symbol] | [symbol] | [symbol] | [symbol] | [symbol] |
| Tlogη = 4 | [symbol] | [symbol] | [symbol] | [symbol] | [symbol] | [symbol] | [symbol] | [symbol] | [symbol] |
| K1c | [symbol] | [symbol] | [symbol] | [symbol] | [symbol] | [symbol] | [symbol] | [symbol] | [symbol] |
| Logarithm | [symbol] | [symbol] | 12.6 | [symbol] | [symbol] | [symbol] | [symbol] | 12.6 | [symbol] |
| of surface | | | | | | | | | |
| resistivity | | | | | | | | | |
| (Ω/sq) | | | | | | | | | |
| Logarithm | — | — | 13.3 | — | — | — | — | 13.5 | — |
| of surface | | | | | | | | | |
| resistivity | | | | | | | | | |
| (Ω/sq) after | | | | | | | | | |
| strengthening | | | | | | | | | |
| Logarithm | — | — | — | — | — | — | — | — | — |
| of hopping | | | | | | | | | |
| frequency, | | | | | | | | | |
| logωp | | | | | | | | | |
| Peel resistance | — | — | — | — | — | — | — | — | — |
| of antifouling | | | | | | | | | |
| layer; contact | | | | | | | | | |
| angle (°) | | | | | | | | | |
| Rate of | [symbol] | [symbol] | 1600 | [symbol] | [symbol] | [symbol] | [symbol] | 3200 | [symbol] |
| devitrification | | | | | | | | | |
| propagation | | | | | | | | | |
| (μm/hour) | | | | | | | | | |
| Liquidus | — | — | 1210-1220 | — | — | 1230-1240 | 1220-1230 | 1220-1230 | 1210-1220 |
| temperature | | | | | | | | | |
| (° C.) | | | | | | | | | |
| β-OH (mm⁻¹) | — | — | 0.31 | — | — | — | — | — | — |

As shown in Tables 1 to 5, the glasses of the Working Examples each had a low surface resistivity in the unstrengthened state and had satisfactory devitrification properties. Meanwhile, G45, which is a Comparative Example, had a high entropy function and a high surface resistivity. G46, which had a high total alkali content, had a low K1c.

G47 and G48, which are Comparative Examples each having a high Al₂O₃ content and a low Na₂O+K₂O, were each a glass having a high liquidus temperature, a high devitrification propagation rate, and poor devitrification properties.

### <Properties Imparted by Chemical Strengthening>

Some of the glasses were subjected to chemical strengthening (ion exchange) treatments under the conditions shown in Tables 6 and 7. In the tables, the expression “Na50-K50” used for strengthening salt means that a molten salt having an Na:K molar ratio of 50:50 was used. In the case of a glass having an entry also in the section “Ion exchange 2”, this means that a second-stage chemical strengthening treatment was performed. In the case of a glass having no entry therein, this means that a first-stage chemical strengthening treatment only was performed.

The obtained chemically strengthened glasses were examined for surface compressive stress (value) (CS) and depth of compressive stress layer (DOL) with a surface stress meter (surface stress meter FSM-6000, manufactured by Orihara Industrial Co., Ltd.). The chemically strengthened glasses were further examined for internal CS and DOL using a scattered-light photoelastic stress meter (SLP-1000). In Tables 6 and 7, “CS1” denotes a compressive stress value at a depth of 50 μm from the surface layer and “CS2” denotes the CS of the surface layer. Furthermore, “Dl” denotes DOL measured with the scattered-light photoelastic stress meter and “D2” denotes a depth of compressive stress layer measured with the surface stress meter and indicates the depth to which potassium ions had penetrated. Each blank in the tables means that the property was not determined.

### <Surface Resistivity, Hopping Frequency, and Peel Resistance of Antifouling Layer>

The chemically strengthened glasses were evaluated for surface resistivity, hopping frequency, and peel resistance of an antifouling layer by the same methods as for the glasses which had not been chemically strengthened. The results thereof are shown in Tables 6 and 7. Each blank in the tables means that the property was not determined.

TABLE 6

| | | S1 | S2 | S3 | S4 | S5 | S6 | S7 | S8 | S9 | S10 |
|---|---|---|---|---|---|---|---|---|---|---|---|
| Glass composition | | G2 | G12 | G27 | G28 | G29 | G30 | G31 | G32 | G33 | G34 |
| Thickness t (mm) | | 0.55 | 0.7 | | 0.55 | | | | | | |
| Ion exchange 1 | Strengthening salt | Na50- | K95- | K95- | Na50- | K95- | K95- | K95- | K95- | K95- | K95- |
| | | K50 | Na4.5- | Na4.5- | K50 | Na4.5- | Na4.5- | Na4.5- | Na4.5- | Na4.5- | Na4.5- |
| | | | Li0.5 | Li0.5 | | Li0.5 | Li0.5 | Li0.5 | Li0.5 | Li0.5 | Li0.5 |
| | Temperature (° C.) | 380 | 400 | 400 | 425 | 400 | 400 | 400 | 400 | 400 | 400 |
| | Treatment period (h) | 2 | 6 | 6 | 3 | 6 | 6 | 6 | 6 | 6 | 6 |
| Ion exchange 2 | Strengthening salt | Nal-K99 | | | Na2-K98 | | | | | | |
| | Temperature (° C.) | 450 | | | 400 | | | | | | |
| | Treatment period (h) | 1 | | | 1 | | | | | | |
| Stress profile | CS1 | 92 | 126 | 122 | 180 | 123 | 84 | 103 | 102 | 113 | 113 |
| | D1 | 110 | 121 | 128 | 110 | 132 | 132 | 133 | 130 | 127 | 126 |
| | CS2 | 1072 | 1229 | 906 | 970 | 717 | 1033 | 720 | 676 | 896 | 887 |
| | D2 | 5.7 | 3.6 | 3.9 | 5.2 | 4.1 | 5.0 | 4.5 | 4.5 | 4.2 | 4.3 |

| | | | | | | | | | | |
|---|---|---|---|---|---|---|---|---|---|---|
| Logarithm of surface resistivity (Ω/sq) | 13.8 | 13.9 | | | | | | | | |
| Logarithm of hopping frequency, logωp | 4.04 | 3.97 | 4.24 | 3.99 | 4.28 | 3.62 | 2.92 | 2.65 | 3.88 | 3.72 |
| Peel resistance of antifouling layer; | 89 | 61 | 51 | 68 | 58 | 64 | 55 | 61 | Si | 74 |
| contact angle (°) | | | | | | | | | | |

TABLE 7

| | | S11 | S12 | S13 | S14 | S15 | S16 | S17 | S18 | S19 | S20 | S21 | S22 |
|---|---|---|---|---|---|---|---|---|---|---|---|---|---|
| Glass composition | | G35 | G36 | G37 | G44 | G45 | G46 | G56 | G57 | G58 | G59 | G60 | G65 |
| Thickness t (mm) | | | | 0.6 | 0.55 | | | | | | | | |
| Ion exchange | Strengthening | K95- | K95- | K95- | Na100 | Na100 | K95- | K95- | K95- | K95- | K95- | K96.5- | K96.5- |
| 1 | salt | Na4.5- | Na4.5- | Na4.5- | | | Na4.5- | Na4.5- | Na4.5- | Na4.5- | Na4.5- | Na3.5 | Na3.5 |
| | | Li0.5 | Li0.5 | Li0.5 | | | Li0.5 | Li0.5 | Li0.5 | Li0.5 | Li0.5 | | |
| | Temperature | 400 | 400 | 400 | 380 | 450 | 400 | 400 | 400 | 400 | 400 | 390 | 390 |
| | (° C.) | | | | | | | | | | | | |
| | Treatment period | 6 | 6 | 6 | 2 | 1.5 | 6 | 6 | 6 | 6 | 6 | 4 | 4 |
| | (h) | | | | | | | | | | | | |
| Ion exchange | Strengthening | | | | | Na1-K99 | | | | | | | |
| 2 | salt | | | | | | | | | | | | |
| | Temperature | | | | | 425 | | | | | | | |
| | (° C.) | | | | | | | | | | | | |
| | Treatment period | | | | | 1.5 | | | | | | | |
| | (h) | | | | | | | | | | | | |
| Stress profile | CS1 | 106 | 100 | 97 | 61 | 93 | | 130 | 101 | 102 | 103 | | |
| | D1 | 131 | 134 | 134 | 69 | 107 | | 129 | 127 | 129 | 130 | | |
| | CS2 | 826 | 750 | 726 | | 90.7 | | 619 | 701 | 720 | 738 | | |
| | D2 | 4.3 | 4.7 | 4.7 | | 7.3 | | 3.7 | 5.3 | 5.2 | 5.0 | | |

| | | | | | | | | | | | |
|---|---|---|---|---|---|---|---|---|---|---|---|
| Logarithm of surface resistivity | | | | 14.2 | 13.4 | | | | | 13.3 | |
| (Ω/sq) | | | | | | | | | | | |
| Logarithm of hopping frequency, | 3.88 | 3.83 | 3.74 | 2.52 | 5.52 | 3 | 3.1 | 3.3 | 3.6 | 3.2 | 3.6 |
| logωp | | | | | | | | | | | |
| Peel resistance of antifouling | | | | 37.6 | 82.4 | | | | | | |
| layer; contact angle (°) | | | | | | | | | | | |

S14, which is a Comparative Example in which G44 having a low Al₂O₃ content had been used, had poor properties imparted by the chemical strengthening and was unable to have the required strength.

While the present invention has been described in detail and with reference to specific embodiments thereof, it will be apparent to one skilled in the art that various changes and modifications can be made therein without departing from the spirit and scope thereof

### REFERENCE SIGNS LIST

1 Comb-shaped electrodes

11 First comb-shaped electrode

12 Second comb-shaped electrode

1. A glass comprising, in mole percentage on an oxide basis:
60-75% of SiO₂;
8-20% of Al₂O₃;
5-16% of Li₂O; and
2-15% of one or more kinds of Na₂O and K₂O in total,
wherein
a ratio P_{Li} of the content of Li₂O to a total content of Li₂O, Na₂O, and K₂O is 0.40 or more, and
a total content of MgO, CaO, SrO, BaO, and ZnO is 0-10%.

2. The glass according to claim 1, having a value of S represented by the following expression of 0.37 or less,
S=−P_{Li}×log(P_{Li})−P_{Na}×log(P_{Na})−P_{K}×log(P_{K})
wherein
P_{Li}=[Li₂O]/([Li₂O]+[Na₂O]+[K₂O])
P_{Na}=[Na₂O]/([Li₂O]+[Na₂O]+[K₂O])
P_{K}=[K₂O]/([Li₂O]+[Na₂O]+[K₂O]),
provided that [Li₂O], [Na₂O], and [K₂O] respectively indicate the contents in mol percentage of Li₂O, Na₂O, and K₂O.

3. The glass according to claim 1, comprising, in mole percentage on an oxide basis, one or more kinds of Y₂O₃, La₂O₃, and ZrO₂ in a total amount of 0.5-8%.

4. The glass according to claim 1, having a fracture toughness value K1c of 0.70 MPa·m^{½} or more.

5. The glass according to claim 1, wherein a total content of MgO and CaO is 0.1-3% in mole percentage on an oxide basis.

6. The glass according to claim 1, wherein a total content of SrO, BaO, and ZnO is 1.5% or less in mole percentage on an oxide basis.

7. The glass according to claim 1, wherein the total content of MgO, CaO, SrO, BaO, and ZnO is less than 1% in mole percentage on an oxide basis.

8. The glass according to claim 1, wherein the content of K₂O is 1% or less in mole percentage on an oxide basis.

9. The glass according to claim 1, having a surface resistivity at 50° C. of 10¹³ Ω/sq or less.

10. The glass according to claim 1, having a temperature (T2), at which a viscosity is 10² dPa·s, of 1,700° C. or less.

11. A chemically strengthened glass having a surface compressive stress value of 600 MPa or more and having a base glass composition comprising, in mole percentage on an oxide basis:
60-75% of SiO₂;
8-20% of Al₂O₃;
5-16% of Li₂O; and
2-15% of one or more kinds of Na₂O and K₂O in total,
wherein
a ratio P_{Li} of the content of Li₂O to a total content of Li₂O, Na₂O, and K₂O is 0.40 or more,
a total content of MgO, CaO, SrO, BaO, and ZnO is 0-10%, and
the chemically strengthened glass has a hopping frequency of 10^{2.8} Hz or more.

12. The chemically strengthened glass according to claim 11, wherein the base glass composition has a value of S represented by the following expression of 0.37 or less,
S=−P_{Li}×log(P_{Li})−P_{Na}×log(P_{Na})−P_{K}×log(P_{K})
wherein
P_{Li}=[Li₂O]/([Li₂O]+[Na₂O]+[K₂O])
P_{Na}=[Na₂O]/([Li₂O]+[Na₂O]+[K₂O])
P_{K}=[K₂O]/([Li₂O]+[Na₂O]+[K₂O]),
provided that [Li₂O], [Na₂O], and [K₂O] respectively indicate the contents in mol percentage of Li₂O, Na₂O, and K₂O.

13. The chemically strengthened glass according to claim 11, comprising, in mole percentage on an oxide basis, one or more kinds of Y₂O₃, La₂O₃, and ZrO₂ in a total amount of 0.5-8%.

14. The chemically strengthened glass according to claim 11, having a surface resistivity at 50° C. of 10¹⁵ Ω/sq or less.

15. The chemically strengthened glass according to claim 11, having a layer of a fluorine-containing organic compound formed on at least a part of surfaces thereof.

16. A cover glass comprising the chemically strengthened glass according to claim 11.
